(19) United States
(12) Patent Application Publication
(10) Pub. No.: US 2007/0163412 A1
(43) Pub. Date: Jul. 19, 2007

(54) Methods and apparatus for movable machining tools, including for wall saws

(76) Inventors: Anthony Baratta, Oak Park, CA (US); Andreas Jonsson, Kumla (SE)

Correspondence Address: HENRICKS SLAVIN AND HOLMES LLP;SUITE 200, 840 APOLLO STREET, EL SEGUNDO, CA, 90245, US

(21) Appl. No.: 11/331,588

(22) Filed: Jan. 15, 2006

(51) Int. Cl. B26D 1/00

(52) U.S. Cl. 83/651; 83/663

(57) ABSTRACT

A movable machining element, for example a wall saw, can have one or more characteristics including a reversible driving head, a driving head removable from a carriage and having a quick release or quick lock mechanism, a driving head that is removable from a carriage without the use of threaded fasteners or having to unthread a holding element for removing the driving head from the carriage, a driving head with parallel, concentric or coaxial travel elements and tool driving elements, a tool driving assembly including a travel gear accessible from more than one direction, a component in the machining element having an oriented fiber or other composite incorporated in or as part of the component, an eccentric lateral adjustment assembly, or a drive shaft having a non-circular driving surface, for example a hexagonal drive shaft. In a wall saw, a blade and blade flange assembly are easily assembled on the saw or removed from the saw.

### BACKGROUND

1. Field

This relates to movable machining equipment, in one example wall saws.

2. Related Art

Movable machining equipment can be heavy and sometimes difficult or time-consuming to assemble and/or maneuver for use. In some equipment, that have powered transport or movement mechanisms, the transport mechanisms are incorporated in the structures that drive the machining mechanisms, so that the transport mechanisms and the machining mechanisms are effectively integrated into a single unit. In other equipment where the transport and machining mechanisms are more easily separable, the two mechanisms can be stored or moved to a job site as separate components and then assembled for use, but assembly and disassembly can be time-consuming and/or cumbersome.

With some movable machining equipment, for example wall saws, operators may need to make adjustments part way through a given job. For example, when cutting an opening in a concrete wall, thick walls may require starting the cut with one blade size and finishing the job only after removing the first blade and substituting a larger blade. This blade change out can be more difficult when the saw is mounted on a wall or on a ceiling. In another example, the operator may need to reorient the saw relative to the cutting surface to finish the job, which also can be cumbersome or time-consuming.

### SUMMARY

Movable machining equipment, for example wall saws, can be easier to move and use by being lighter, more compact or by being operable over a wider range of conditions or environments. In some instances, for example in some wall saw jobs, the equipment can be operated with larger blades from the beginning of the job without needing as many blade changes, or any needed blade changes can be made easier.

In one example of a movable machining element, for example a wall saw, a carriage is provided for moving along a surface. A movement or transport element is supported by the carriage for moving the carriage along the surface and a drive element is removably supported on the carriage for advancing the movement or transport element. The drive element can access the movement or transport element through two configurations or orientations. In one example, the drive element can be reversible, for example so that a saw blade with the drive element can cut in either of two orientations, such as forward and in the opposite direction. In another example, the drive element is removably supported by the carriage at a first position on the carriage with the drive element having an engagement surface adapted to engage a first complementary element on the carriage. The drive element can be movable to a second position on the carriage at which the engagement surface on the drive element engages a second surface element on the carriage. In a wall saw example, the movement element may be a rack drive element for moving the carriage along a track, such as a gear for engaging the rack. The carriage may include an opening and the rack drive element may be accessible from two sides of the rack drive element. In one configuration, the rack drive element that is accessible from two sides is centered width-wise in the carriage.

In another example of a movable machining element, the moving or transporting assembly moves in a first direction. A drive assembly is supported on the moving or transporting assembly, and each include respective engagement elements for releasably securing the two assemblies together. A manual engagement release releases one engagement from the other. In one example, the manual engagement release may be a handle, and the handle may be spring or otherwise biased, for example to a latched or other locking position. In another example, the manual engagement release may have an opened configuration and a latched or secured configuration. In a further example, it may have more than two configurations, for example an opened configuration, a holding or non-removable configuration (such as where the drive assembly is not removable from the moving work transporting assembly) and a latched or secured configuration. In a further example, the manual engagement release can be actuated or moved from the opened configuration by action, movement or contact by the drive assembly. In one configuration, the manual engagement release can include a tab or other contact area on the manual engagement release that is accessible to the drive assembly when the manual engagement release is in the opened configuration. When the drive assembly contacts the tab, the manual engagement release moves from the opened configuration to the holding configuration, the latched configuration, or to another configuration other than the opened configuration. Engagement and release can be accomplished through a latch system, a releasable locking element such as an over-center configuration or pivoting pin and cam surface engagement, an interlocking system, a ratchet and pawl configuration, a releasable slide, or other releasable securement. Any of these configurations can be used on wall saws and comparable machining tools.

In a further example of a movable machining element, in one example a wall saw, a carriage is for moving along a surface and supports a cutting head in such a way that the head is removably mounted on the carriage. The cutting head and carriage have surfaces that engage each other and one of the engagement surfaces is movable into contact with its corresponding engagement surface and they are held in engagement with each other without having to thread or un-thread a threaded element, for example a nut or a bolt. In one configuration, a movable element is supported by the carriage and has a second surface at least partly complementary to a first surface on the carriage and wherein the two surfaces are relatively movable into and out of engagement with each other between an operating configuration and a separated configuration without the use of threads or a threaded engagement, such as those using multiple rotations to thread or un-thread a fastening bolt. In one example, a cutting head is movable into engagement with the carriage along a plane parallel to a plane of the cutting blade. In this example, drive gears for the carriage may also move in a plane parallel to the cutting blade, which orientations allows easier engagement between the cutting head and its drive gear on one hand, and the corresponding driven gear in the carriage on the other hand. In another example, the cutting head may move laterally into engagement with the carriage. In one configuration for lateral movement, the cutting head can move straight sideways into engagement with holding surfaces keeping the head from lifting off the carriage, and the cutting head can be kept from backing out by a locking pin, slide or other blocking element. In another configuration for lateral movement, the cutting head can have a first portion engaging the carriage and another portion pivoting sideways into engagement with the carriage, for example under a cantilever, ledge or other structure preventing upward movement of the cutting head. The cutting head would be held in place by a locking pin, slide or other blocking element keeping the cutting head from pivoting out of engagement with the carriage. The first portion of the cutting head could engage the carriage through a pivot pin, or other pivot-enabled link.

In another example of a movable machining tool, a machining tool head or drive assembly includes a drive for the machine tool and a drive for a carriage on which the machine tool head is supported. In one example, the machine tool drive and the carriage drive are supported on a common shaft, or are on concentric axes. In another example, the machine tool drive and the carriage drive include respective gears oriented parallel to each other, concentric, or are nested one within the other. In a further example, the machine tool drive gear turns within the carriage drive gear.

In an additional example of a movable machining tool, for example a concrete wall saw, the saw has a carriage for moving the saw along a surface and a single off-center gear for engaging a rack on a track wherein the single off-center gear is the only gear extending from an underside of the carriage. The carriage can have a single centered gear extending at an upper portion of the carriage to be accessible by a mating gear in a removable and reversible cutting head. In this configuration, the carriage can remain in position and the cutting head can drive a cutting blade in one configuration and the cutting head reversed to drive the cutting blade in another configuration. The mating gear in the cutting head is accessible when the cutting head is in either position.

In another example of a movable machining tool, the machining tool includes a housing having a housing surface formed at least in part from a composite of reinforced material. In one configuration, a composite layer of oriented-fiber reinforced plastic is mounted to the housing. A bonding layer may be used to mount the composite layer to the housing, for example through a line or width of adhesive between a perimeter portion of the composite layer and the housing. Portions of the housing under the composite layer may be removed to form cavities or recesses, for example to decrease the weight of the housing. Bonding surfaces may be formed to extend into or through the cavities or recesses for additional bonding sites interior to the perimeter of the composite layer. The composite layer can be formed in a number of ways, including an eight harness or other configurations, including those discussed in International Publication Number WO 2003/080304, dated 2 Oct. 2003, by Electrolux Professional Outdoor Products, Inc., the disclosure of all of which is incorporated herein by reference for all purposes.

In a further example of a movable machining tool, the machining tool includes a gearbox or other transmission assembly having a transfer or intermediate gear between an input gear and an output gear. The transfer gear includes a transfer gear shaft. In one configuration, the gearbox is supported by a drive head through one or more fasteners, wherein one fastener passes through the transfer gear shaft. In another configuration, the transfer gear has sides and the transfer gear is supported by at least one bearing assembly substantially within the sides of the transfer gear. In the example described herein, two bearing assemblies support the transfer gear while being positioned substantially between the sides of the transfer gear.

In an additional example of a movable machining tool, the tool is driven by a tool shaft, which in turn is driven by a drive gear. The tool shaft and the drive gear engage each other through a non-circular engagement surface. In one configuration, the engagement surface can include a flat surface, including multiple flats, and in another configuration, the engagement surface can have a hexagonal configuration. In a further configuration, the tool shaft can also have a non-circular engagement surface for engaging the tool and/or for engaging a tool support structure, for example a blade flange. In another configuration, the tool shaft can be axially movable relative to the drive gear

In another example of a movable machining tool, for example a wall saw, the tool is supported on a movable arm or other movable support structure. The movable arm includes a first plurality of engagement elements distributed substantially uniformly about a support surface on the arm. The tool includes a support configured to be supported on the support surface of the arm and the support has an engagement surface that can engage the engagement elements on the support surface. In one example, there are 18 engagement elements on the support surface on the arm and there is one pin, rod or bolt on the support for the tool to engage the engagement elements. The engagement element in the respective engagement surface is preferably configured so as to properly align whenever at least one engagement element and one engagement surface are in contact. The support for the tool can be supported on the support surface of the arm regardless of whether the arm is up, down or sideways. With the desired alignment between the engagement surface and the corresponding engagement elements, other elements such as a drive shaft and the tool can be properly aligned for mounting and holding on the arm. In a further configuration, the tool and its support can be brought into contact with the support surface on the arm through head on axial movement or through sideways movement when space in the axial direction is limited. For example, in wall saws, sideways movement of the tool onto the support surface on the arm may be preferable when the saw is next to a wall or floor and it is difficult to maneuver the blade on the saw.

An additional example of a movable machining tool includes an adjustment element, such as for lateral or vertical adjustment, having an eccentric shaft, column or similar support. With an eccentric shaft, a roller or other bearing surface can be used as a positioning element and the roller can be symmetric rather than eccentric. In a further configuration, the eccentric shaft can be supported at one end portion by an eccentric sleeve, cup or other support allowing the eccentric shaft to pivot while the one end portion is still supported.

In another example of a movable machine tool, the machine tool can have a moving carriage for supporting a removable driving head for the tool. The driving head can be placed on the carriage through a pivoting movement, and then locked in place on the carriage through a second pivoting movement. The second pivoting movement can be through a structure on the carriage, for example a handle. In one configuration, the first and second pivoting movements are in the same plane relative to each other. For example, in a wall saw, the pivoting movements may be in a plane parallel to the plane of the saw blade. In another configuration, the first movement of the driving head can include placing a portion of the driving head on the carriage, and the driving head can have a further movement pivoting about an axis, for example a vertical axis, into engagement with the carriage. The second pivoting movement can then lock the driving head with the carriage. In another configuration, the locking movement can be other than a pivoting movement. For example, the locking movement can be a slide movement, such as a pin, bar or other blocking element. A number of locking movements can be accomplished without the use of threads, for example without threading a fastener in to lock the driving head and threading a fastener out to unlock the driving head. In several configurations, the driving head can be locked in place through a pivoting movement of less than 90 degrees, and it can be unlocked through a reverse pivoting movement of less than 90 degrees. In a further configuration, the driving head can be positioned under or against a blocking element for holding that portion of the driving head in place. The blocking element may be a cantilever element, overhang, angled surface or other structure suitable for holding the adjacent portion of the driving head in place. More than one such blocking element may be used.

In a further example of a movable machining tool, the machining tool can have a moving carriage and a driving head removably supported by the carriage. The driving head can be locked in place by moving a handle on the carriage from a first position to a second position. The first position may be an open position and the second position may be a locked position. The handle may also have an intermediate or holding position for holding the driving head relatively stationary on the carriage until the driving head can be locked down. In one example, positioning the driving head against a tab on the handle assembly moves the handle assembly from the open position to the holding position. The handle can then be manually moved from the holding position to the locked position. The driving head can be unlocked by depressing a bias element and moving the handle to the open position. The bias element can be incorporated into the handle assembly.

In a further example of a movable machining tool, the working tool element can be mounted on the movable machine by moving a tool assembly having the tool element sideways relative to the machine. Turning a fastener moves the tool assembly into engagement with a drive shaft. The tool assembly and the drive shaft may have hexagonal engagement surfaces for driving the tool. The faster may be threaded and may be biased toward the tool assembly so that turning the fastener begins threading of the fastener into the tool assembly. The tool may be driven by a drive gear having a hexagonal surface for engaging the drive shaft.

In a further example of a movable machining tool, for example a wall saw, the tool may be removably mounted to and supported by a carriage that moves along a surface. The tool may be removed from the carriage and reversed and replaced on the carriage for further operation without changing the positioning or orientation of the carriage.

Examples are set forth more fully below in conjunction with drawings, a brief description of which follows.

### BRIEF DESCRIPTION OF THE DRAWINGS

FIG. 1 is an isometric view of one example of a movable machining element in the form of a wall saw on a track.

FIG. 1A is a side elevation view of a track bracket used in mounting the track of FIG. 1.

FIG. 2 is an isometric and exploded view of the wall saw of FIG. 1 showing a driving element removed from a carriage.

FIG. 3 is a top plan view of the wall saw of FIG. 1.

FIG. 4 is a side elevation view of the wall saw of FIG. 3 taken along line 4-6 showing the driving element in a position to be pivoted further into engagement with the carriage.

FIG. 5 is a side elevation and partial cutaway view of the wall saw of FIG. 3 taken along line 4-6 showing the driving element in a second position pivoted into engagement with the carriage, having contacted a tab area on a handle to move the handle into a holding position.

FIG. 5A is an enlarged view of a portion of the handle and a portion of the driving head in which the handle keeps the driving head from being removed from the carriage.

FIG. 6 is a side elevation and partial cutaway view of the wall saw of FIG. 3 taken along line 4-6 showing the driving element in the second position with a handle in a third position locking the driving head on the carriage.

FIG. 6A is an enlarged view of a portion of the handle and a portion of the driving head on the carriage in which the handle locks the driving head in place.

FIG. 7 is a side elevation and partial cutaway view of the wall saw of FIG. 3 taken along line 7-7 showing the driving head captured laterally on the carriage and showing a support structure for the handle assembly, with the handle also showing a lateral adjustment assembly for the carriage.

FIG. 7A is a detailed view of the support structure for the handle assembly of FIG. 7.

FIG. 7B is a cross sectional view of the carriage taken along line 7B-7B of FIG. 3.

FIG. 8 is a plan view of a handle assembly used in the wall saw of FIG. 1.

FIG. 9 is a side elevation view of the handle assembly of FIG. 8.

FIG. 10 is a transverse cross-sectional view of the handle assembly taken along line 10-10 of FIG. 9.

FIG. 11 is a cross-sectional view and partial schematic of the driving head assembly taken along line 11-11 of FIG. 3 along with a mating travel gear assembly of the carriage shown in phantom.

FIG. 12 is a plan view of a drive gear assembly from the driving head of the wall saw of FIG. 1 and a travel gear assembly from the carriage of the wall saw of FIG. 1.

FIG. 13 is a cross-sectional view of the drive gear assembly taken along line 13-13 of FIG. 12.

FIG. 14 is a cross-sectional view of the drive gear assembly and travel gear assembly taken along line 14-14 of FIG. 12.

FIG. 15 is a cross-sectional view of the drive gear assembly similar to that of FIG. 13 and further showing a blade drive input shaft and a mounting ring.

FIG. 16 is a front elevation view of an eccentric side adjustment assembly for use with the carriage of FIG. 1.

FIG. 17 is a side elevation view of the adjustment assembly of FIG. 16.

FIG. 18 is a top plan view of the adjustment assembly of FIG. 16.

FIG. 19 is a longitudinal cross-section of the adjustment assembly of FIG. 18 taken along line 19-19.

FIG. 20 is a side elevation view of the eccentric shaft and eccentric cup support for the adjustment assembly of FIG. 16.

FIG. 21 is a front elevation view of a gearbox, blade mounting flange and water supply manifold of the wall saw of FIG. 1.

FIG. 22 is a top plan view of the gearbox assembly of FIG. 21.

FIG. 23 is a side elevation view of the gearbox assembly of FIG. 21.

FIG. 24 is an isometric view of the gearbox housing of the gearbox of FIG. 21.

FIG. 24A is an isometric view of the gearbox of FIG. 24 with a composite skin layer removed.

FIG. 24B is an isometric view of the composite skin layer of FIG. 24.

FIG. 25 is a rear isometric view of the gearbox housing of the gearbox of FIG. 21.

FIG. 25A is an isometric view of the gearbox of FIG. 25 with a composite skin layer removed.

FIG. 25B is an isometric view of the composite skin layer of FIG. 25.

FIG. 26 is a cross-sectional view of the gearbox assembly of FIG. 21 taken along line 26-26.

FIG. 27 is a front elevation view of the gearbox assembly of FIG. 21 (without the blade mounting flange and water supply manifold) showing the support for the blade mounting flange.

FIG. 28 is a partial cross-section of the gearbox assembly of FIG. 27 taken along line 28-28 showing a blade drive shaft ready to engage a blade flange.

FIG. 29 is an isometric view of the gearbox assembly of FIG. 27 showing the blade shaft extended.

FIG. 30 is a plan view of a blade shaft stub gear for engaging and driving the blade shaft.

FIG. 31 is an isometric view of a blade drive shaft for use with the gearbox assembly of FIG. 21.

FIG. 32 is an isometric view of an inner blade flange assembly for mounting on the gearbox as shown in FIG. 21.

FIG. 33 is a side elevation view of the inner blade flange assembly of FIG. 32.

FIG. 37 is an exploded view from the left front of an inner blade flange assembly used on the blade arm of FIG. 21.

FIG. 38 is an exploded view from the left rear of the inner blade flange assembly used on the blade arm of FIG. 21.

FIG. 39 is a side elevation view of a collar used with the inner blade flange assembly of FIG. 21.

FIG. 40 is a front elevation view of a pin and spacer used in the collar of FIGS. 38 and 39.

FIG. 41 is a rear elevation view of the inner blade flange assembly of FIG. 21.

### DETAILED DESCRIPTION

This specification taken in conjunction with the drawings sets forth examples of apparatus and methods incorporating one or more aspects of the present inventions in such a manner that any person skilled in the art can make and use the inventions. The examples provide the best modes contemplated for carrying out the inventions, although it should be understood that various modifications can be accomplished within the parameters of the present inventions.

Examples of machining tools and of methods of making and using the machining tools are described. Depending on what feature or features are incorporated in a given structure or a given method, benefits can be achieved in the structure or the method. For example, tools using carriages with removable driving heads may be easier to use and maintain. They may also take less time in set up, break down and during normal operation. Additionally, some machining tool configurations may also benefit from lighter-weight components, lower-cost and reduced wear, and greater ease in making adjustments in the field. Some machining tool configurations may also allow use of larger tools to begin or end jobs, or allow fewer change outs during a given job.

These and other benefits will become more apparent with consideration of the description of the examples herein. However, it should be understood that not all of the benefits or features discussed with respect to a particular example must be incorporated into a tool, component or method in order to achieve one or more benefits contemplated by these examples. Additionally, it should be understood that features of the examples can be incorporated into a tool, component or method to achieve some measure of a given benefit even though the benefit may not be optimal compared to other possible configurations. For example, one or more benefits may not be optimized for a given configuration in order to achieve cost reductions, efficiencies or for other reasons known to the person settling on a particular product configuration or method.

Examples of tool configurations and of methods of making and using the tools are described herein, and some have particular benefits in being used together. However, even though these apparatus and methods are considered together at this point, there is no requirement that they be combined, used together, or that one component or method be used with any other component or method, or combination. Additionally, it will be understood that a given component or method could be combined with other structures or methods not expressly discussed herein while still achieving desirable results.

Wall saws are used as examples of machining tools that can incorporate one or more of the features and derive some of the benefits described herein, and in particular concrete wall saws. Wall saws are often heavy and drive very large saw blades, especially compared to the sizes of the track and the hardware used to drive the saw blade itself. However, movable machining tools other than wall saws can benefit from one or more of the present inventions.

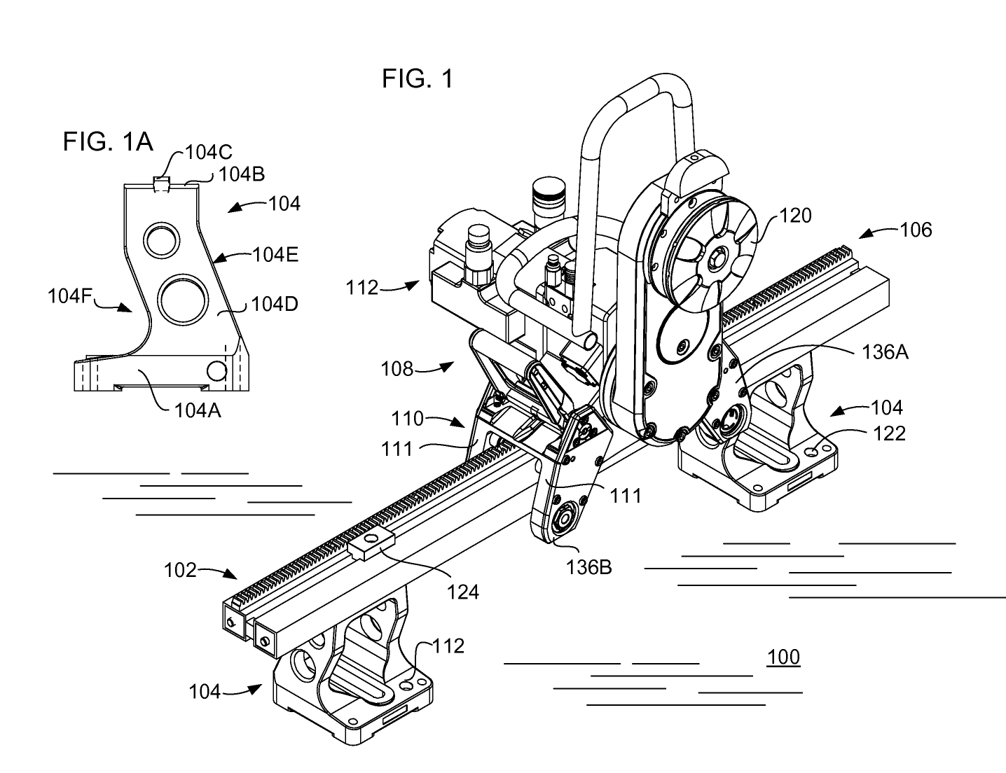

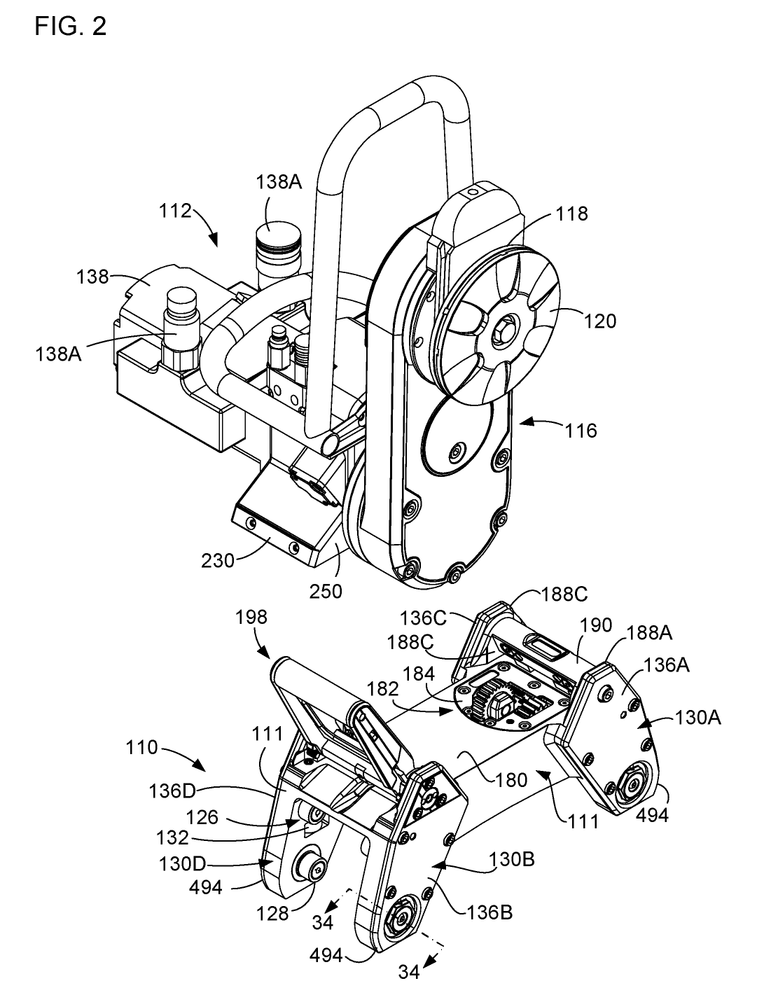

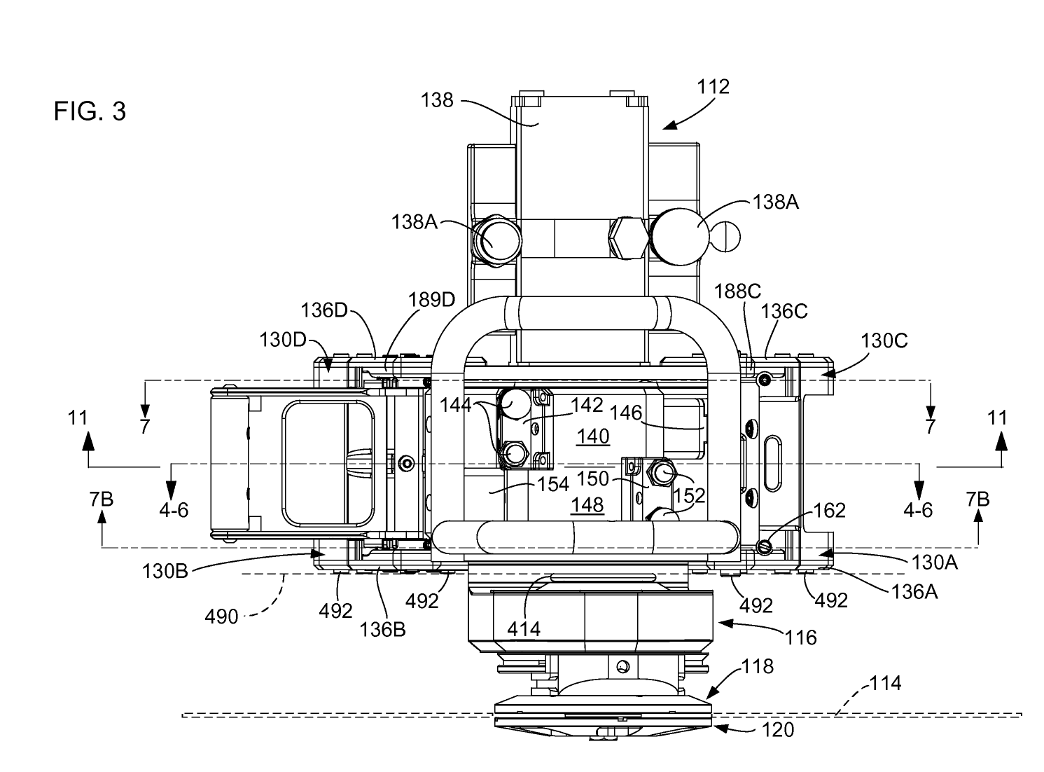

One example of a wall saw is shown in FIGS. 1-3, in which are shown a concrete surface 100 (FIG. 1), and a track 102 mounted to the concrete surface through track brackets 104. In the track 102 shown in FIG. 1, the track includes a pair of parallel beams fixed together, one of which has a gear track 106 along which the saw 108 travels. The saw includes a carriage 110 supporting a drive assembly and tool support, collectively referred to as the drive assembly 112. The carriage 110 is formed from a carriage body 111 (FIGS. 1 and 2) and various components mounted to the carriage body, as described more fully below. A blade 114 (FIG. 3) is supported on a blade arm/gearbox 116 by inner and outer blade flanges 118 and 120, respectively.

The track brackets 104 include mounting bolts or screws (not shown), level indicators 122 (FIG. 1) and one or more mounting clamps 124 for fixing the track to the brackets. The track bracket 104 has a base 104A substantial enough to receive and support the fasteners to hold the bracket against the concrete surface. The top of the bracket 104B is substantially flat and parallel to the base except for a ridge 104C extending upward from the surface of the bracket top, and extending from front to back of the bracket for engaging a groove or the spacing in the bottom of track. The ridge 104C is substantially centered on the top 104B, and is also substantially centered relative to the base 104A. The length from front to back of the top 104B is slightly less than the length of the base. The top is supported on the base by two spaced apart legs 104D extending upward and slightly toward each other from the base to the top. Each leg is a substantial mirror image of the other and extends upward from the base at an angle from one side toward the other to an elbow portion 104E, and then extends substantially straight upward to the top. The width of each leg is substantially the same from top to bottom except for a transition area into the base. Each leg includes one or more openings to decrease the weight of the track bracket. A recessed area 104F gives clearance for the use of tools.

As shown in FIG. 1, the gear track 106 is not centered on the track, but instead is offset to one side. If a cut is to be made on the near side of the track shown in FIG. 1, the blade 114 is mounted on the saw and brought in the contact with the concrete surface when up to speed. A line is then cut in the concrete to the desired depth by moving the saw along the track 102. If a cut is to be made on the far side of the track shown in FIG. 1, the drive assembly 112 can be lifted (with the blade flange assembly removed) and removed from the carriage 110 and rotated in a plane parallel to the concrete surface 180 degrees and repositioned on the carriage so that the blade is positioned on the far side of the track. A line can then be cut in the concrete without having to remove or reposition the carriage on the track, as will become apparent herein.

Considering the carriage 110 in more detail with respect to FIGS. 1-4, the carriage is mounted and positioned on the track through various rollers. The carriage is supported on the top of the track by upper rotatable rollers 126 vertically and horizontally fixed to an under side of the carriage 110. The present carriage uses eight upper rollers. The carriage is supported from below the track by lower adjustable rotatable rollers 128. The lower rollers are axially movable relative to the side legs 130A-D of the carriage, so they can be withdrawn into the legs to give clearance for placing the carriage on the track or removing the carriage. The lower rollers include assemblies having eccentric components for adjusting the position of the rollers, thereby more closely securing the carriage on track. In the present example, there is one lower roller for each leg of the carriage. The positions of the lower rollers can be adjusted upward and downward, or closer to or farther from the track. The directional designations of “upper” and “downward” and other directional designations are made relative to the track, to the drawing orientation or other similar reference point. Because the track and wall saw can be mounted on vertical, horizontal and other oriented surfaces, the directional designations are not made relative to a horizon unless otherwise specifically noted.

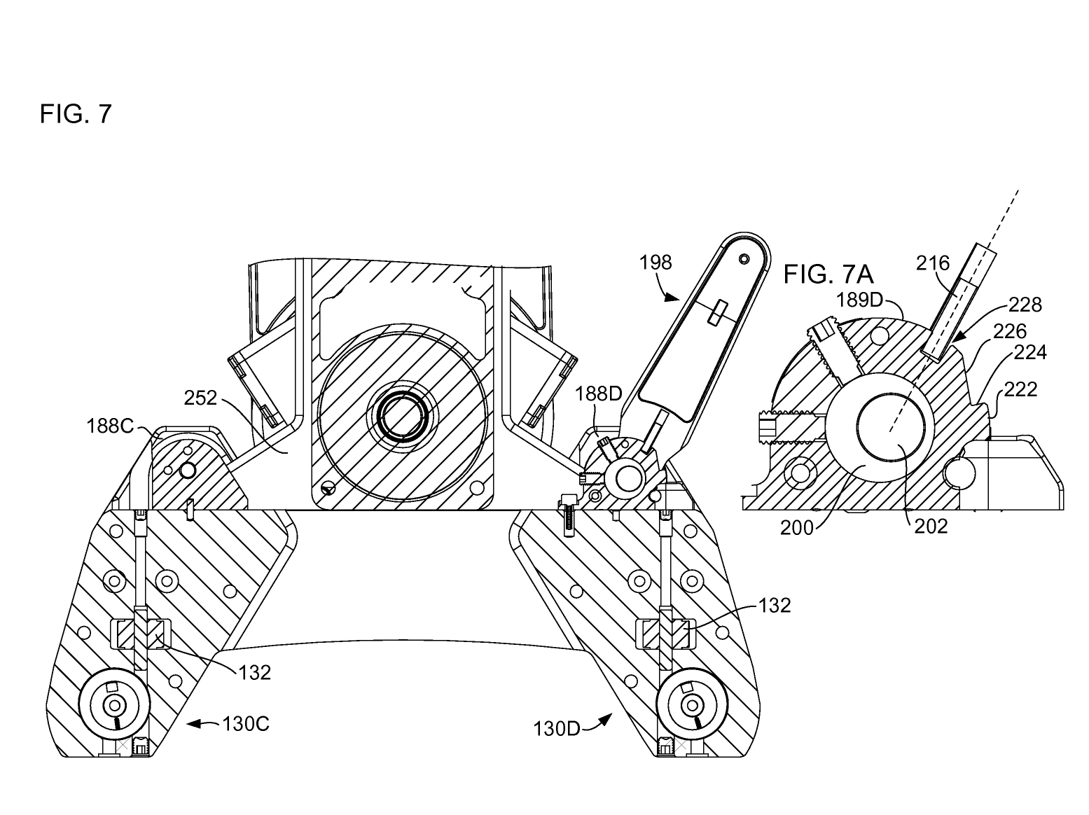

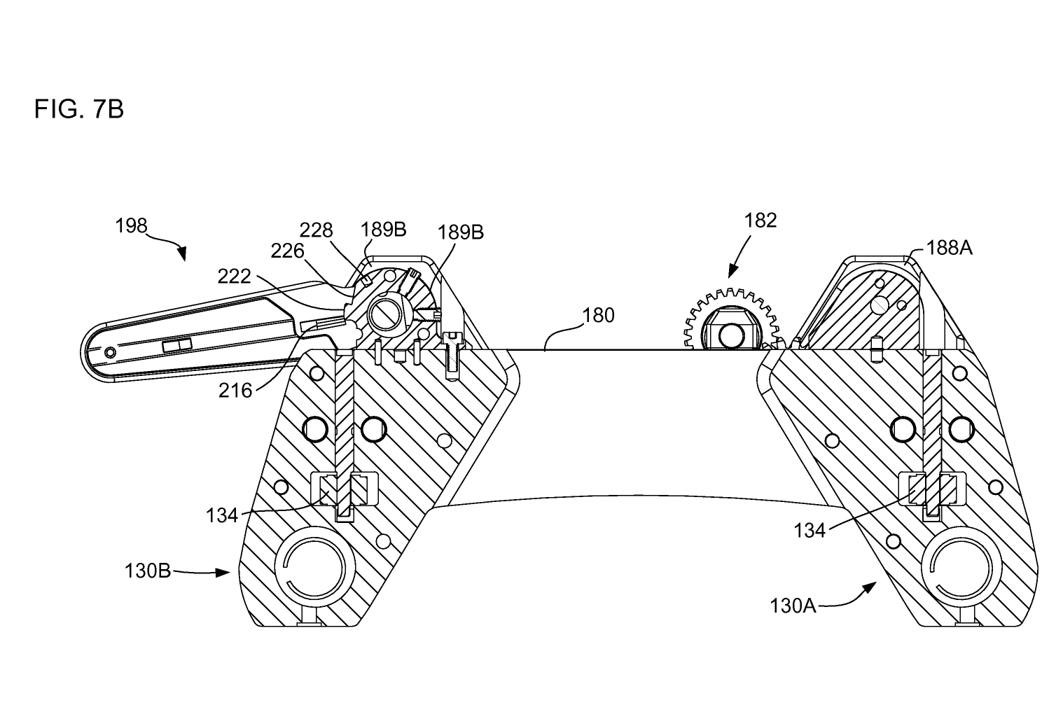

The carriage also includes side rollers 132. Each leg includes one side roller. As shown in FIG. 7, the side rollers in the two legs 130C and 130D are adjustable side rollers 134. These adjustable side rollers include symmetric rollers on eccentric shafts, as described more fully below with respect to FIGS. 16-20.

The carriage also includes a plurality of side plates 136A-D mounted to corresponding sides of the carriage (FIGS. 1 and 2). Each side plate has a profile in a lower portion that preferably conforms to the shape of its adjacent leg 130. The upper portion of each side plate is configured to adequately support adjacent hardware, such as mounting blocks or other structures that supporting the handle, transverse bar and other components described more fully below. Each side plate is mounted to the carriage through respective fasteners, in the present example, two lower fasteners into its adjacent leg and two upper fasteners, one into the carriage platform and one into the portion of the carriage where the leg joins the platform or a side wall of the carriage. The side plates provide structural support for the carriage and the components holding the drive assembly on the carriage. For example, loading in directions parallel to the side plates represent shear forces. For example, the fasteners through the side plates can more easily withstand the shear forces than they can withstand pull out forces such as might occur in fasteners mounted vertically in the carriage, such as might be used to mount the handle to the carriage (see the fastener mounting the handle assembly in FIG. 7B). Additionally, the side plates can more easily support the loading applied through the bushings 200. The material of the side plates can be the same as that of the carriage, for example aluminum, or the material can be different. For example, can aluminum carriage can use side plates formed from stainless-steel or from a composite material. A suitable composite material may include carbon or glass fiber reinforced plastic or epoxy or other material. The reinforcement can also be other materials is well. The reinforcement is preferably an oriented or patterned reinforcement. The composite material may be an eight harness layup or other configurations, such as those described in International Publication Number WO 2003/080304, incorporated herein by reference, and in patent publication No. U.S. 2004-0007225, also incorporated herein by reference.

The drive assembly 112 includes a blade drive motor 138 with appropriate hydraulic fittings 138A for driving the blade drive motor. The blade drive motor drives the saw blade 114. The drive assembly 112 also includes a carriage travel or feed motor designated generally as 140, which includes a housing formed in the drive assembly, a manifold 142 with appropriate hydraulic fittings 144 and cover plate 146. The carriage travel motor 140 drives the carriage along the track through travel gears in the carriage ultimately engaging the rack 106, discussed more fully below. The drive assembly 112 also includes a blade height control motor or arm control motor designated generally as 148, which includes a housing formed in the drive assembly, a manifold 150 with appropriate hydraulic fittings 152 and a cover plate 154. The arm control motor 148 moves the blade arm including the gearbox 116 about a central axis defined by the blade driving shaft in the drive assembly. The blade arm can typically move through an arc of 360 degrees and more. The carriage travel motor 140 and the arm control motor 148 typically include worm drive gears to drive respective complementary gears in the drive assembly, described more fully below. These worm drive gears are conventional and are not described further. Manual carriage feed controls and arm controls can be used in place of the feed and arm control hydraulic motors.

The carriage 110 and the drive assembly 112 can be stored and carried separately, and the carriage can be placed on the track separate from the drive assembly. As shown in FIG. 2, the drive assembly is removable from the body of the carriage. The carriage can be mounted on the track separately from the drive assembly by first pressing outwardly each of the four lower rollers 128 so that the inwardly facing surfaces of each roller are substantially flush with the inside surfaces of the legs 130. The carriage is placed over the track so that the upper rollers 126 rest on the top surfaces of the track and the travel gear engages the rack 106. The lower rollers are then pressed inward under the track to support the carriage from below.

Before the first use, and thereafter as adjustments may be needed over time due to wear, the side rollers 134 are adjusted to closely guide the carriage along the track without significant lateral play (FIG. 7B). Considering the adjustable roller 134 in more detail with respect to FIGS. 16-20, and its location in the carriage as shown in FIG. 7B, the adjustable roller assembly includes an eccentric shaft 156 and a symmetric wear roller 158. The roller is symmetric about a central axis through the center of the opening which receives the shaft 156. The roller 158 includes a high wear outer surface, for example that provided by a cam follower bearing assembly, supported on the shaft 156.

The shaft 156 includes an accessible slotted end 160. The slot 162 extends along a diameter of the shaft. The slot 162 allows an operator to turn the shaft 156 about a central axis 164. The shaft 156 includes a first upper symmetric portion 166 and an intermediate symmetric portion 168 on each side of a circumferential groove 170 for receiving a tool through an opening in the carriage for releasing the shaft from the bore. A set screw (not shown) holds the shaft in place vertically by pressing against the upper portion 166. The upper and intermediate portions 166 and 168 are symmetric about the axis 164. An eccentric shaft portion 172 extends below the intermediate portion 168 and is itself symmetric about an offset axis 174 for supporting the roller 158 and moving the roller about the axis 164 when the shaft 156 is rotated within its bore in the carriage. The shaft 156 terminates in a reduced diameter end portion 176, also symmetric about the offset axis 174. The end portion 176 extends into and is supported by an eccentric cup 178, which is part of the adjustable roller assembly 134. The cup includes a cavity slightly larger than the end portion 176 for receiving the end portion, and an outer diameter approximately the same as the outer diameter of the symmetric portion of the shaft 156, so that the cup can turn in the bore when the slotted shaft is turned. The cup 178 helps to support the shaft 156 against lateral forces applied to the roller 158 while allowing the shaft 156 to pivot during adjustment.

During assembly, the cup 178 is placed in the bore for the shaft by inserting the cup from the side of the carriage through the opening through which the roller will extend for guiding the carriage. The roller is inserted into the same opening and the shaft 156 inserted in the bore and into the cup 178. A set screw is then threaded into the carriage adjacent the shaft. During adjustment, the side of the carriage with the fixed side rollers is pressed against the track. The set screws for the adjustable rollers are loosened and each of the eccentric shafts in the adjustable roller assemblies are turned until any undesirable lateral movement of the carriage on the track is eliminated. The lateral adjustment of the carriage can then be left alone until wear or other circumstances require re-adjustment.

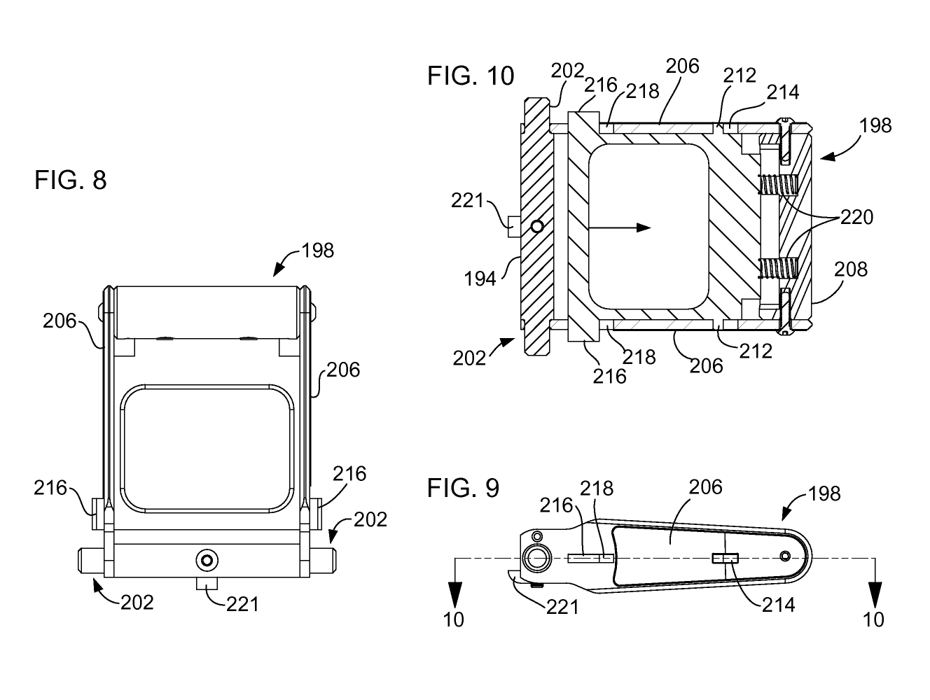

With the carriage reliably positioned on the track, the carriage can support and reliably hold the drive assembly relative to the track, thereby allowing reliable and accurate cutting by the blade 114. The carriage can support and hold the drive assembly in a number of ways, some of which do not use bolts or other threaded fasteners in the process of locking down or securing the drive assembly on the carriage or which do not use bolts or other threaded fasteners in releasing the drive assembly from the carriage. In the examples shown in the drawings (FIGS. 1-11), the drive assembly is held in place by a number of elements, one or several of which help to hold the drive assembly from movement in a given direction, and the others of which help to hold the drive assembly from movement in other directions. Additionally, of the number of elements, all but one are fixed relative to the carriage and help to hold the drive assembly in place. The remaining one is movable from a first position, allowing the drive assembly to be placed on the carriage and removed from the carriage, to a second position securing the drive assembly in place on the carriage. In other configurations of a carriage and drive assembly, more than one of the holding elements can be movable into and out of holding positions and still reliably hold the drive assembly on the carriage.

In the example shown in FIGS. 1 -11, the carriage 110 has a number of elements helping to hold the drive assembly in place on the carriage. Base or lower support from the carriage comes from the carriage platform 180 extending substantially flat from a rearward portion of the carriage to a front portion of the carriage. The carriage is formed from a first preferably strong structural material, but lightweight, such as aluminum, and includes harder and more wear-resistant structures that will frequently come into contact with the drive assembly. For example, a rearward portion of the carriage includes a travel or feed gear assembly 182 supported by and retained in a relatively hard, wear-resistant metal frame including a mounting plate 184, which may be made out of stainless-steel. One part of the drive assembly can contact and move along the mounting plate 184 as the drive assembly is being placed on the carriage. The mounting plate 184 and the rest of the carriage platform 180 helps to support drive assembly from below.

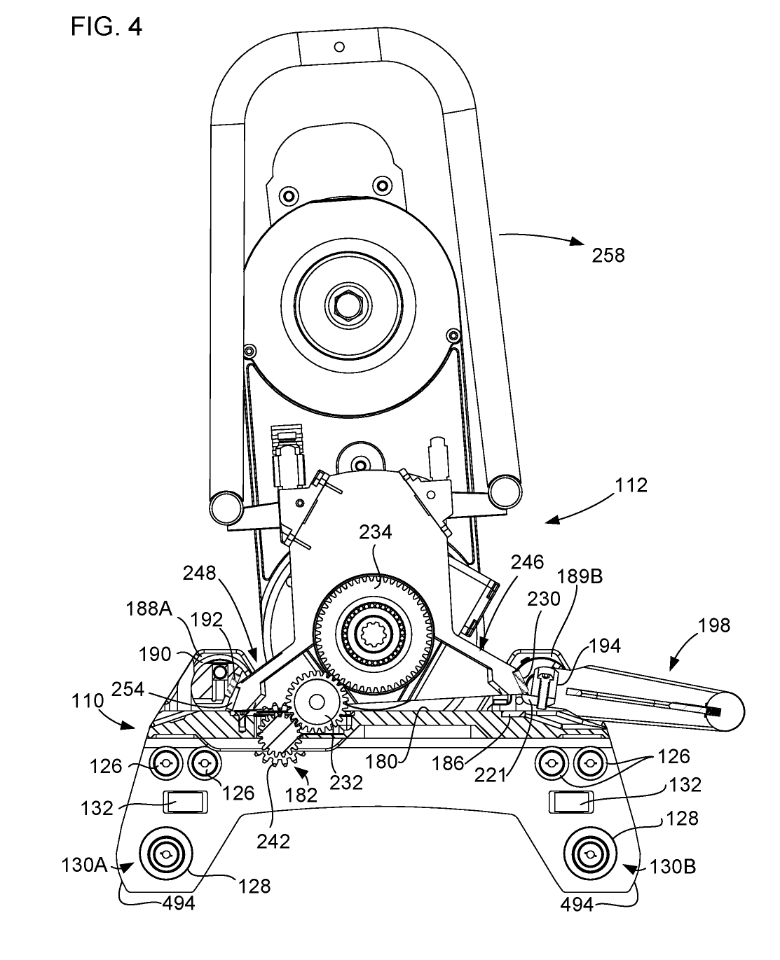

The carriage platform also includes another relatively hard, wear-resistant support portion in the form of a second wear plate 186 (FIGS. 4-6). The second wear plate 186 is positioned and secured to a front portion of the platform 180 to support a second portion of the drive assembly. The second wear plate 186 and mounting plate 184 extend a substantial width of the platform 180. Any of the wear plates and other often contacting surfaces in the carriage may be formed from stainless steel or similar materials. The rest of the platform underneath the drive assembly supports the adjacent surfaces on the drive assembly where they come into contact.

Lateral or sideways support from the carriage for the drive assembly is provided partly on the outside by the side plates 136A-D and partly by up-standing side panels 188A and 188C and 189B and 189D at the front and rear side portions, respectively, of the carriage. The side panels 188A and C are formed integral with or monolithic with the transverse bar that they support on the carriage. The side panel 188A is mounted above the leg 130A, and the side panel 188C is above the leg 130C. The side panels 189B and D are formed integral with or are fastened to the handle assembly for supporting the handle assembly through the adjustment bushings, described more fully below. The side panel 189B is mounted above the leg 130B, and the side panel 189D is above the leg 130D.

The carriage provides support for the drive assembly from above the drive assembly by a transverse bar 190 mounted and fixed to and extending between the side walls 188A and 188C. The transverse bar 190 in this example defines with the adjacent portion of the platform 180 a concave or recessed area for receiving a portion of the drive assembly 112. The recessed area engages a portion of and helps to hold the drive assembly in place on the carriage, in the present example from two directions, namely from a rearward direction and from an upward direction. The transverse bar 190 at its upper extent extends out over an adjacent portion of the drive assembly in a way similar to the way a cantilever might extend over a structure and keep the structure from moving past the cantilever. The transverse bar 190 includes a relatively strong, wear-resistant wear plate 192, against which a corresponding wear plate on the drive assembly comes to rest (described more fully below).

The drive assembly supports described to this point with respect to the drawings are fixed relative to the carriage under normal circumstances, and typically are not moved during normal usage. While one or more of the supports may be held in place by fasteners or other reversible means, these supports in the present example remain stationary when the drive assembly is put in place in the carriage and when the drive assembly is removed from the carriage. Moving one or more of the supports to allow installation and removal of the drive assembly would be more time-consuming than is necessary under the circumstances. The drive assembly can be installed and removed without putting in or removing fasteners and without shifting or otherwise moving the supports. In other examples, one or more of the supports can be removable and replaceable or otherwise movable to allow insertion and removal of the drive assembly and still reliably support and hold the drive assembly in place during operation.

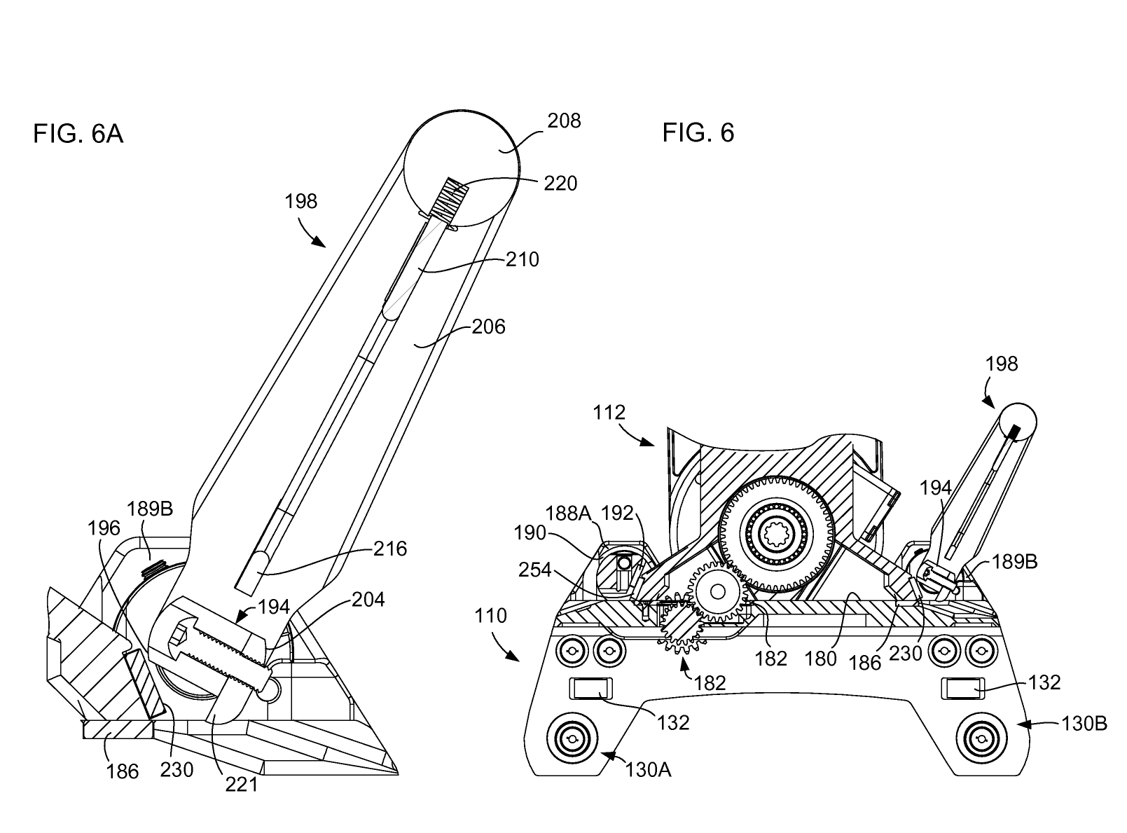

In the example shown in the drawings (FIGS. 1-11), an additional support is provided on the carriage. This support is movable from an open or non-holding position on the carriage relative to the drive assembly to a locked or holding position on the carriage where the drive assembly is locked or held in place. In the present example, the additional support is included in a handle assembly (though it need not be), and the additional support is a bar 194 extending transversely between the side walls 136B and 136D. The bar 194 is changeable from a first configuration where a blocking surface 196 is farther from the transverse bar 190, and therefore farther from a drive assembly when the drive assembly is in place, to a second configuration where the blocking surface 196 is bearing against an adjacent surface of the drive assembly, thereby holding the drive assembly in place against at least one of the other support elements. In the present example, the bar 194 is changed between the first and second configurations by a handle assembly 198. For example, the handle assembly moving from an open position shown in FIG. 4 to a closed position shown in FIGS. 6-6A moves the bar 194 from a relatively opened position to a locking position, where the surface 196 bears against the adjacent portion of the drive assembly, locking the drive assembly in place.

In the present example of changing the bar 194 using the handle, changing the bar is relatively simple. Moving the bar from an open configuration to a closed configuration can be carried out using a single continuous motion in moving the handle. The handle motion follows an arc over a relatively small angle in order to secure the drive assembly in place. This arcuate or pivoting motion can be easily incorporated in the carriage or similar structure to hold a drive assembly in place. A continuous motion, in the present example an arcuate motion, also can be used to reliably release the bar 194 to an open or unlocked position.

While the present arcuate or pivoting motion of the bar 194 can hold and release the drive assembly, other changes or movements can be used to open or release and hold or secure the drive assembly. For example, the bar 194 can be moved laterally over the platform 180 into contact with the drive assembly, or the bar can be moved longitudinally or axially (sideways relative to the carriage) to extend over a portion of the drive assembly. In another example, the bar could pivot about one end of the bar in the plane of the platform 180 into and out of contact with the drive assembly. Multiple bars or pins can be used to hold and release the drive assembly, for example a bar or pin at each corner of the end of the drive assembly, or of both ends of the drive assembly. Another support configuration may use a ratchet and pawl assembly, an over center configuration, an inter-locked configuration, including a hook or dove tail arrangement, a sliding, latch or other locking arrangement as well as a cam and pin arrangement where either the cam or pin move along a surface on the other so as to more closely contact or to move away from the drive assembly, in a manner similar to a bayonet mount.

Considering the carriage 110 and the handle assembly 198 in more detail with respect to FIGS. 4-10, the left and right side panels 189B and 189D and outward of those the left and right side plates 138B and 138D support respective collars or bushings 200 (FIG. 7A), which in turn support respective lubricated end portions 202 of the bar 194 within eccentric openings in the bushings 200. The interface between the bushings and the end portions may be lubricated using zircs, such as recessed zircs to reduce the side profile of the carriage. The bar 194 is freely rotating at its respective ends relative to the eccentric bushings 200 so that the handle assembly can move relative to the bushings 200. Movement of the bushings within the respective left and right side walls allows adjustment of the bar 194 by moving the bar 194, and therefore the handle assembly, closer to or farther from the adjacent surface of the drive assembly 112. The eccentric bushings 200 allow adjustment of the position of the blocking surface 196 (FIG. 6A) relative to the drive assembly. The eccentric bushings 200 are locked in place by a pair of set screws in the respective side walls. During adjustment, the drive assembly is installed, the handle placed in its locked position, and the set screws loosened. One bushing is then rotated until the bar 194 contacts the drive assembly. The top set screw for the bushing just adjusted is tightened. The other bushing is then adjusted in the same way, and its top set screw tightened. The drive assembly is removed and the lower set screws tightened.

The bar 194 has the cross-sectional profile shown in FIG. 6A having opposite spaced apart flat surfaces, a relatively uniformly curved cam surface 196 to be positioned next to and brought into contact with the drive assembly 112, and an opposite curved surface 204. The flat and curved surfaces are positioned approximately equal distances from a center axis of the bar 194.

The handle includes a releasable handle-position fixing, latching or locking assembly. The bar 194 supports two spaced apart side panels 206 in the handle assembly 198, and the side panels are fastened at their ends opposite the bar 194 to a cross bar 208. The side panels 206 support and guide a latching plate 210 that slides longitudinally of the handle assembly between the bar 194 and the cross bar 208. The latching plate 210 includes guide tabs 212 sliding within guide openings 214 in the side panels. Latching tabs 216 slide within guide openings 218, and extend beyond the outer surfaces of the side panels to contact and engage respective ones of the side panels 189B and 189D, as described more fully below. The latching plate 210 is biased into engagement with the side walls by one or more springs 220 extending between the cross bar 208 and the latching plate 210. Therefore, the handle assembly 198 includes a biased latching element that can latch or lock or otherwise hold the handle assembly in one or more selected positions.

In the present example, the handle assembly also includes an actuation element 221 on the bar 194. In the present example, the handle can be moved from one position to another without using hand motion on the handle, either to release the handle or to move the handle. In the present example, the actuation element may be a tab, shoulder, lip, ledge or other accessible surface that allows the drive assembly or an extension thereof to contact the actuation element as the drive assembly begins to approach the carriage for positioning the drive assembly on the carriage. Clearance is provided in the carriage for allowing the actuation element to move with the handle assembly without hitting the surface of the carriage, over the expected range of handle motion of the actuation element.

In the examples shown in the drawings, the handle assembly is configured to have at least three distinct positions, but less than three or more than three positions can be used. One position is a fully open position where the drive assembly can be freely installed in or removed from the carriage assembly 110. The fully open position is represented in FIG. 4. The handle assembly 198 extends below horizontal (relative to the view shown in FIG. 4) and the latching tabs 216 rest and are biased against respective tabs 222 on the respective side panels 189B and 189D (FIGS. 7-7B). The handle can freely pivot in both directions along the surfaces of the tabs 222 until the latching tabs 216 reach the upper ends 224 of the tabs 222. As the latching tabs 216 pass the ends 224, the springs 220 bias the latching plate 210 toward the bar 194 so that the latching tabs come to rest against intermediate surfaces 226 on respective ones of the side panels 189B and 189D. The intermediate surfaces 226 represent a holding position for the handle assembly, where the handle assembly is configured as described herein, such that the handle assembly does not move to the open position without depressing the latch plate 210 against the spring bias. In the holding position, the handle assembly holds the drive assembly in place on the carriage, substantially preventing removal of the drive assembly. In the present example, the holding position is configured by positioning the bar 194 relative to the drive assembly so as to prevent removal of the drive assembly, as discussed more fully below. The intermediate surfaces 226 include first substantially straight segments followed by slightly arcuate surfaces, and they terminate at latching or locking recesses 228.

When the handle moves to a position where the latching tabs 216 enter and are retained in the latching recesses 228, where the handle assembly is configured as described herein, the handle assembly is in a locked configuration such that the handle assembly does not move from the position or out of the locked configuration without depressing the latch plate 210 against the spring bias. The handle assembly is in the third position when the latching tabs are captured in the latching recesses 228. In the third position, as represented in FIGS. 6-7A, the bar 194 bears against an adjacent portion of the drive assembly to hold the drive assembly in place against the other support elements of the carriage. In the examples shown in the drawings, the blocking surface 196 on the bar 194 bears against a wear plate 230 (FIG. 6A), and contacts the wear plate along a line of contact having a length determined by the common lengths between the wear plate 230 and the bar 194. Because the latching tabs 216 are recessed in the latching recesses 228, the blocking surface 196 locks down the drive assembly until the handle assembly is released.

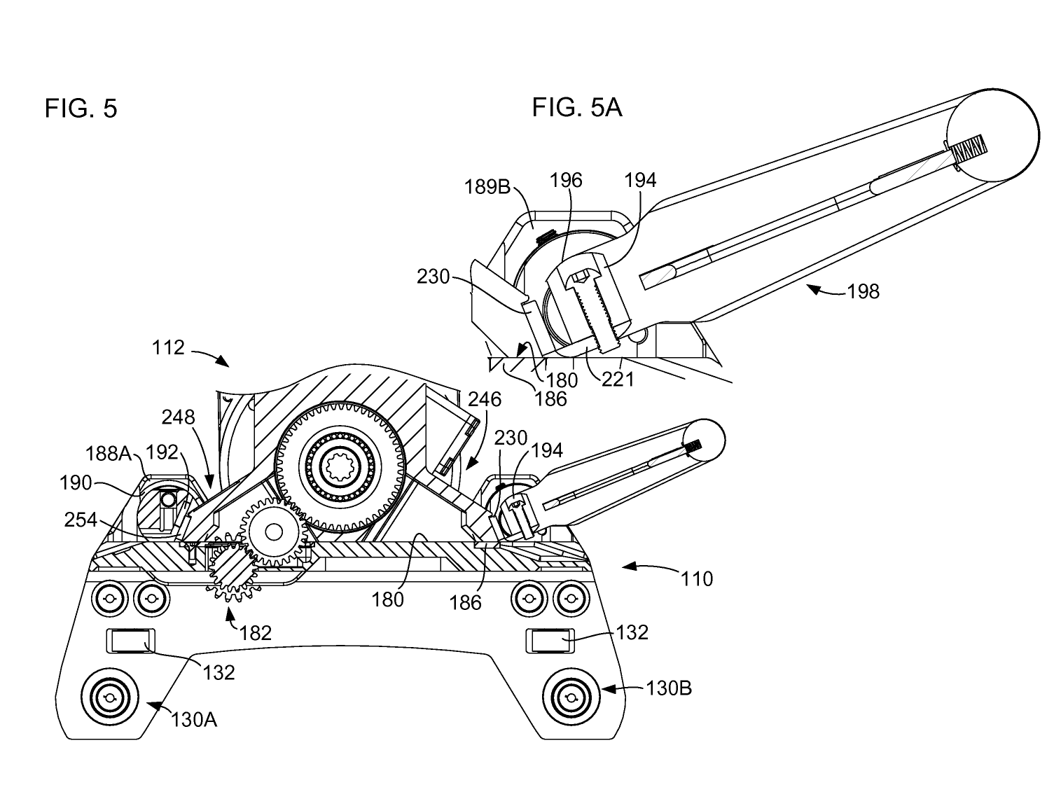

The three distinct positions of the exemplary handle assembly comprise one open position and two holding positions. The open position allows insertion and removal of the drive assembly. The intermediate holding position substantially prevents removal of the drive assembly from the carriage, while still allowing some movement. The intermediate holding position places the bar 194 in such a way that removal of the drive assembly is substantially prevented, unless the handle assembly is moved to the open position. As shown in FIG. 5A, the bar 194 extends sufficiently far over the adjacent portion of the drive assembly that the drive assembly cannot move upward past the bar. The third position holds the drive assembly against the carriage and prevents any significant movement of the drive assembly relative to the carriage, and therefore relative to the track. In an example of two distinct positions, the handle assembly can have a fully open position and a holding positioned equivalent to the third position that holds the drive assembly against the carriage and prevents any significant movement. Other positions are also possible.

The handle assembly moves through an arc centered on the axis of rotation of the bar 194. The pivot axis location of the bar relative to the drive assembly is determined by the adjustment bushings 200. In the example shown in the drawings, the line of contact between the blocking surface 196 and the wear plate 230 on the drive assembly is substantially perpendicular to the plane of the blade 114. Consequently, the holding force from the bar 194 is applied in a direction substantially parallel to the plane of the blade, which helps to distribute the holding force across the corresponding side of the drive assembly. It also helps to more reliably maintain the drive assembly and therefore the cutting blade aligned with the desired cutting line.

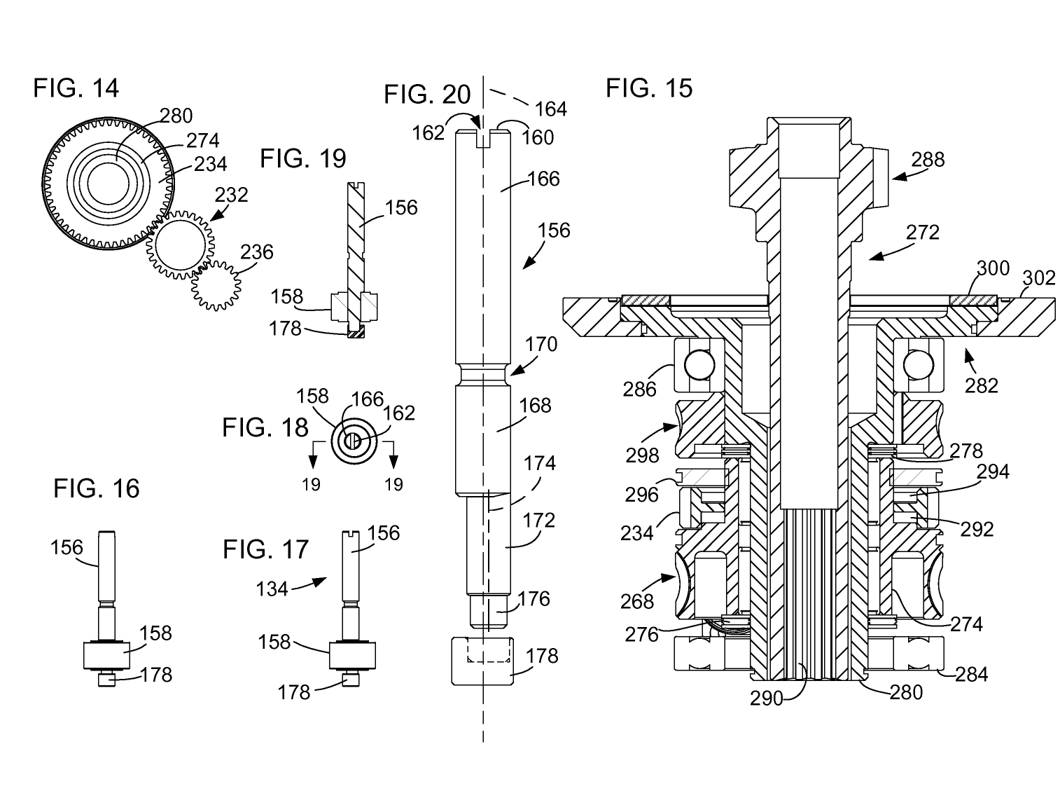

The carriage assembly 110 also includes the feed gear assembly 182. The feed gear assembly 182 includes a mating gear 232 (FIGS. 4-7B and 14), which mates with a travel driving gear 234 in the drive assembly (described more fully below). The mating gear 232 in the present example shown in the drawings is substantially centered widthwise in the carriage, and more specifically widthwise relative to the footprint occupied by the drive assembly where the drive assembly is placed on the carriage. This centering allows the drive assembly to be reversible, as discussed more fully below. In other configurations, the mating gear 232 is positioned so that the drive assembly can be reversible, but positioning for reversibility can be omitted if that feature is not desired. The mating travel gear 232 engages a follower gear 236, which is supported in the carriage on a shaft 238 through bearings 240. The shaft 238 turns the travel gear 242, which is offset in the carriage to engage the rack 106 for moving the saw along the track. The follower gear 236, the shaft 238 and the travel gear 242 are machined from a single piece of material, or may be otherwise integral, though they need not be. In a situation where the track has a rack centered on the track, the travel gear assembly 182 can be reconfigured so that a mating gear similar to mating gear 232 can directly or indirectly move the carriage along the rack.

Considering the drive assembly 112 in more detail with respect to FIGS. 2-7 and 11, the drive assembly includes a body portion 244 for receiving and housing the hydraulic motors or other drive motors and also for housing the drive gears used in the saw. The drive assembly also includes a support portion for contacting the carriage and helping to hold the drive assembly in place on the carriage. The support portion in the example shown in the drawings includes first and second leg portions 246 and 248, respectively, as well as side panels 250 (FIG. 2) and 252 (FIG. 7). The first and second leg portions and the side panels can be considered a form of skirt extending down from the body portion 244 to contact and rest against the carriage and its corresponding support surfaces or support elements. While the leg portions and the side panels can be modified or reconfigured or can take a different structure, the present example shown in the drawings will have the drive assembly supported from four sides, from below and from above. Other configurations for supporting and holding the drive assembly in place on the carriage can be used.

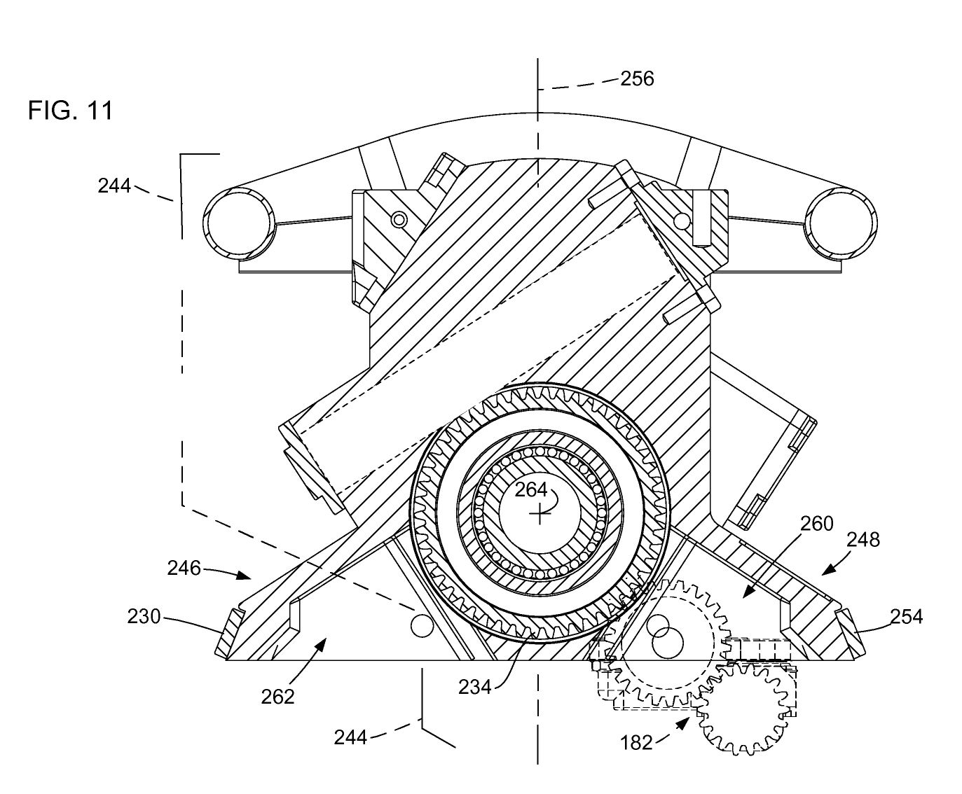

The second leg portion 248 includes at its outer most end the wear plate 230 facing outwardly and slanted or at an angle to the vertical as viewed in FIG. 11. The first leg portion 246 also includes a wear plate 254 substantially identical to the wear plate 230 and serving the same function. When the drive assembly is positioned as shown in FIGS. 4-6, the wear plate 254 bears against the wear plate 192, by which the drive assembly is supported and held in place from the rearward direction when the drive assembly is on the carriage. Each of the wear plates 230 and 254 extend less than or substantially the width of the support portion of the drive assembly, but they preferably extend the same width as each other. All of the wear plates described herein are preferably a harder more wear resistant component than other components in the saw less prone to repeated contact.

The support portion of the drive assembly in the example shown in the drawings is symmetric relative to at least one plane to allow the drive assembly to be reversible on the carriage. In the example shown in FIG. 11, the support portion of the drive assembly is symmetric about a plane extending longitudinal of the drive assembly (transverse to the carriage) and containing the line 256. Also in the example of the drive assembly shown in the drawings, its support portion is substantially symmetric widthwise of the lower most portion of the drive assembly so that the side walls contact the same portions of the carriage when the drive assembly is reversed as compared to when the drive assembly is not reversed. In the example of the drawings, the footprint or outline of the support portion is substantially rectangular, when viewed from below. Other configurations of a support portion can be used to provide the desired symmetry or reversibility when reversibility is incorporated into the design.

Mounting the drive assembly on the carriage in the present example shown the drawings includes an at least partly linear motion to move the drive assembly against one part of the carriage and a pivoting or arcuate motion. In the linear motion, in one example, the second leg portion 248 and the wear plate 254 are moved down toward the carriage and rearward into contact with the wear plate 192 in the rearward direction, and between the side walls 188A and 188C. In the pivoting motion, the drive assembly is pivoted in the direction represented by the arrow 258 (FIG. 4) so that the wear plate 230 on the support portion 246 approaches the actuating element 221 on the handle assembly. The approach is represented in FIG. 4. As downward motion of the support portion 246 continues, the support portion 246 contacts and pushes against the actuating element 221 causing the handle assembly 198 to pivot from the open position shown in FIG. 4 to the intermediate holding position shown in FIGS. 5 and 5A. As represented schematically in FIG. 5A, the wear plate 230 has pressed the actuating element 221 downward to pivot the handle assembly about the center axis of the bar 194. In this position, the latching tabs 216 extend past the end surfaces 224 (FIG. 7A), at which point the end surfaces 224 prevent the handle assembly from returning to the open position without releasing the latching plate 210. In the configuration of the handle assembly 198 and the bar 194 shown in FIGS. 5-5A, the blocking surface 196 on the bar 194 has moved sufficiently over the wear plate 230 on drive assembly to prevent the drive assembly from being removed completely from the carriage. In another configuration of the handle assembly (not shown), the actuating element 221 and the bar 194 can be configured such that the drive assembly can move straight down into contact with the carriage platform, while at the same time pushing on the actuating assembly 221, at which time the blocking surface 196 rotates toward the drive assembly. Thereafter, further rotation of the handle into locking position can push the drive assembly rearward against the wear plate 192, and also engaging travel gears.

The intermediate holding position of the handle assembly represented in FIGS. 5-5A allows an operator to use both hands to assemble the drive assembly onto the carriage. Once the drive assembly is in contact with the carriage and the handle assembly moved to the holding position shown in FIG. 5, the operator can release one hand and use the free hand to move the handle assembly to the fully locked position, represented in FIGS. 6-6A. In the fully locked position, the handle assembly has moved to a position whereby the latching tabs 216 engage the latching recesses 228 (FIGS. 7-7A). In this position, the handle assembly, and therefore the drive assembly, cannot be released without releasing the latching plate 210. As represented in FIGS. 6-6A, the blocking surface 196 on the bar 194 contacts the wear plate 230. When the bar 194 has been adjusted using the eccentric bushings, latching of the handle assembly in the recesses 228 presses the blocking surface 196 firmly against the wear plate 230, thereby pressing the drive assembly firmly against the rearward wear plate 254 (FIG. 6). The bar 194 supports the drive assembly from above and forward of the drive assembly. The side panels 189B and 189D support the side walls and the support portion 246 of the drive assembly, and wear plate 186 (FIGS. 6-6A) supports the drive assembly from below. The sides of the carriage platform support the sides of the drive assembly support portion, and the plate 182, the side walls 188A and 188C support the drive assembly at the support portion 248. The wear plate 254 supports the drive assembly from the back and from above.

To remove the drive assembly, the handle assembly 198 is moved to the open position, for example after releasing the latching assembly. The drive assembly can then be removed from under the wear plate 254 and lifted off the carriage.

Assembling the saw by moving the drive assembly in a plane parallel to the saw blade makes easier proper alignment of the drive assembly relative to the desired cutting line, and also makes easier the proper meshing of the travel gears. The use of wear plates in those areas where repeated contact may cause dimensional changes, thereby affecting the proper alignment of the saw, reduces the possibility of such wear. Other drive assembly movements can be used to assemble the drive assembly on the carriage while still resulting in a secure combination of drive assembly in the carriage, but other wear patterns may result. For example, the drive assembly can include a vertical pin engaging a recess in the carriage, and then the drive assembly can be pivoted in the plane of the carriage platform 180 to properly position the drive assembly on the carriage. Appropriate locking or latching mechanisms can be used to secure the drive assembly on the carriage. Other drive assembly movements may include laterally sliding the drive assembly onto the carriage platform after which the drive assembly is locked in place, or longitudinally sliding the drive assembly on the carriage platform and locking it in place.

In the assembly method depicted in FIGS. 4-6, the drive assembly can be positioned and secured on the carriage without the use of threaded fasteners, and without rotation or multiple turns on a securing device such as a bolt or other threaded fastener. To assemble the drive assembly on the carriage, the handle assembly 198 can be moved through an angle of less than 90 degrees. Other assembly configurations can use slides, pins, bars or other securements not using threading motions to secure the drive assembly on the carriage. Similarly with removal of the drive assembly from the carriage. The drive assembly can be released and removed from the carriage by moving the handle assembly through a relatively short arc, and significantly less than a 360 degree turn on a threaded bolt. Therefore, removal of the drive assembly can be achieved without un-threading any components.

If it is desired, as in the present example shown in the drawings, to have the drive assembly reversible on the carriage, or otherwise to have the drive assembly positioned on the carriage in two configurations, the travel driving gear 234 (FIG. 11) can be made accessible from several directions or several positions. For example, the support portion of the drive assembly can include first and second cavities or recesses 260 and 262, respectively. The first recess 260 permits access to the driving gear 234 for the travel gear assembly 182 from under the first support portion 248 of the drive assembly. Additionally, if the drive assembly were lifted off the carriage and turned 180 degrees about a vertical axis, and replaced on the carriage, the travel gear assembly 182 meshes with the driving gear 234 in the second recess 262 under the support portion 246 of the drive assembly.

To give reliable meshing of the travel gear assembly 182 with the driving gear 234, the driving gear 234 is centered on a longitudinal axis 264 configured to be equidistant from corresponding portions of the outer surfaces of the wear plates 230 and 254 or other support surfaces on the drive assembly contacting the carriage. In the example shown in FIG. 11, the outer portions of the support portions 246 and 260 at the wear plates 230 and 254 are substantial mirror images of each other about the plane bisecting the drive assembly through the line 256. Therefore, the drive assembly is positioned and secured on the carriage in the configuration shown in FIGS. 3-6 the same as it would be when positioned and secured on the carriage after pivoting the drive assembly 180 degrees.

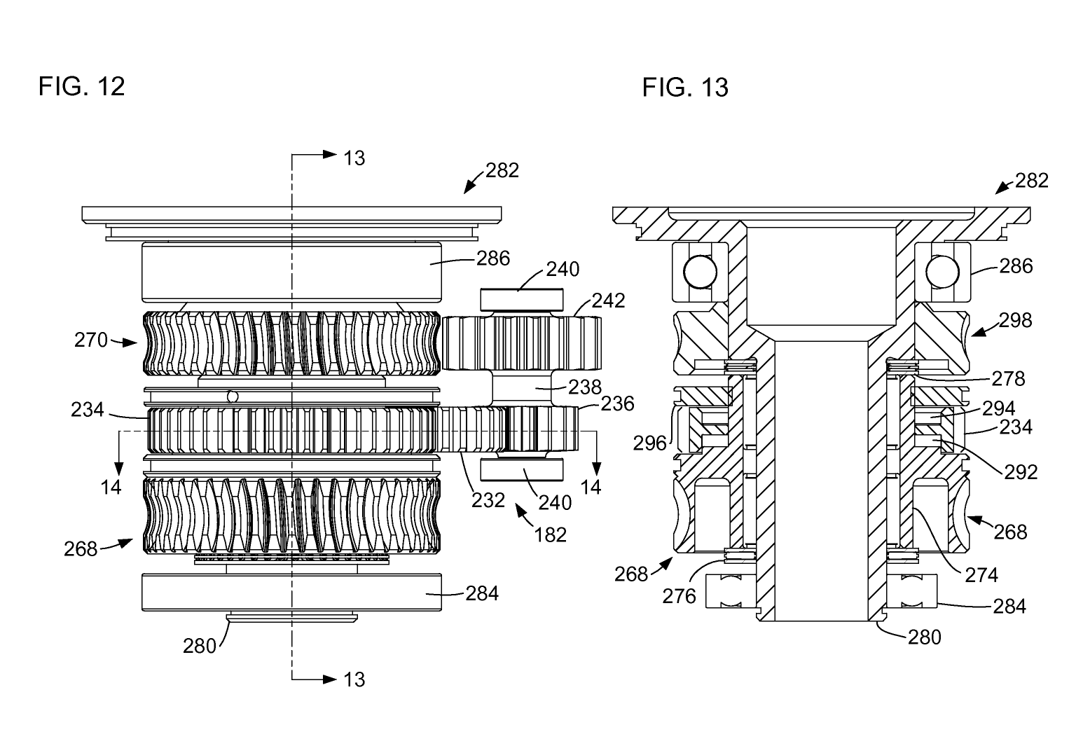

A compact drive assembly can be configured by having the travel driving gear co-axial with one or the other or both of the blade drive shaft and the arm rotation gear. In one example of the drive assembly (FIGS. 12-15), the travel worm gear 268 and the travel driving gear 234 are coaxial with the arm rotation worm gear 270 and a blade drive input shaft 272 (FIG. 15). The travel worm gear 268 includes a worm gear shaft 274 (FIG. 13) extending between thrust bearings 276 and 278. The worm gear shaft 274 is supported through needle bearing assemblies on a bearing housing shaft 280 of a bearing housing 282. The bearing housing is supported within the drive assembly by radial bearings 284 and 286. The blade drive input shaft 272 extends within the bearing housing and is supported by appropriate bearings within the bearing housing concentric with the radial bearings 286 and by bearings in the gearbox adjacent the blade drive input gear 288. The blade drive input shaft includes internal splines 290 for receiving the output shaft of the hydraulic drive motor, which shaft is also supported by appropriate bearings.

The travel worm gear 268 is driven by the travel drive motor 140, having an output drive gear engaging the travel worm gear 268, which would be housed within the bore represented in phantom in FIG. 11, which would be positioned in the drive assembly at a level raised from the plane of the drawing FIG. 11. Driving the travel worm gear 268 turns the worm gear shaft 274, which then turns the travel driving gear 234. The travel driving gear 234 is positioned about the worm gear shaft 274 between spring clutches 292 and 294 which help to press the travel driving gear 234 against the travel worm gear 268 when an internally threaded locking nut 296 is secured against the travel driving gear 234. Suitable O-rings may be placed in O-ring grooves in the travel worm gear, the locking nut 296 and the flange and the input sides of the bearing housing 282.

An arm rotation worm gear 298 is keyed to the bearing housing shaft and driven by an arm rotation motor 148 (FIG. 3) for turning the bearing housing 282, which then pivots the gearbox 116 (FIG. 2) through application of pressure through the clutch ring 300 (FIG. 15). A mounting ring 302 (FIG. 15) sandwiches the flange of the bearing housing 382 between the mounting ring 302 and the adjacent wall of the drive assembly. Six equally spaced apart threaded openings are formed in the mounting ring 302 for receiving mounting fasteners from the gearbox 116.

Having the travel worm gear, the arm rotation worm gear and the blade drive input shaft coaxial with one another reduces the size of the drive assembly, and may reduce the size of the carriage. It may also allow more efficient spacing or positioning of the travel drive motor and of the arm rotation motor. These two motors are oriented at angles with respect to each other, and at acute angles relative to the carriage platform. This may lower the height profile of the drive assembly relative to the drive assembly or carriage assembly where the arm rotation motor and the travel motor are vertical or up right relative to the carriage. Having a coaxial travel gear may also simplify making the drive assembly reversible.

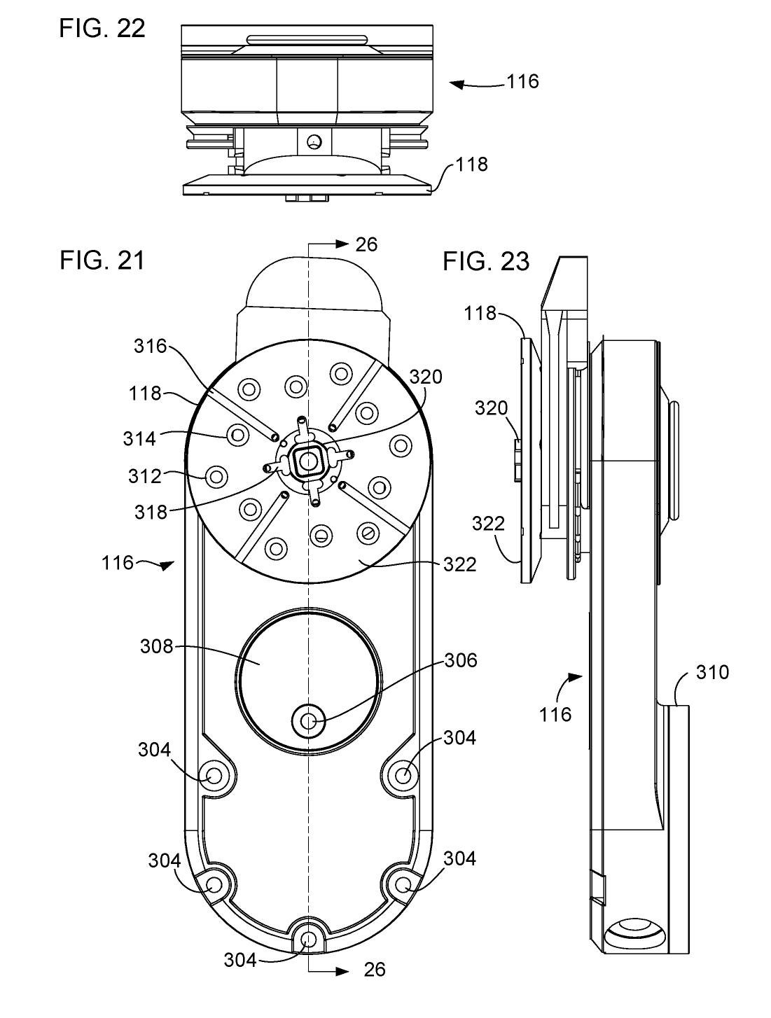

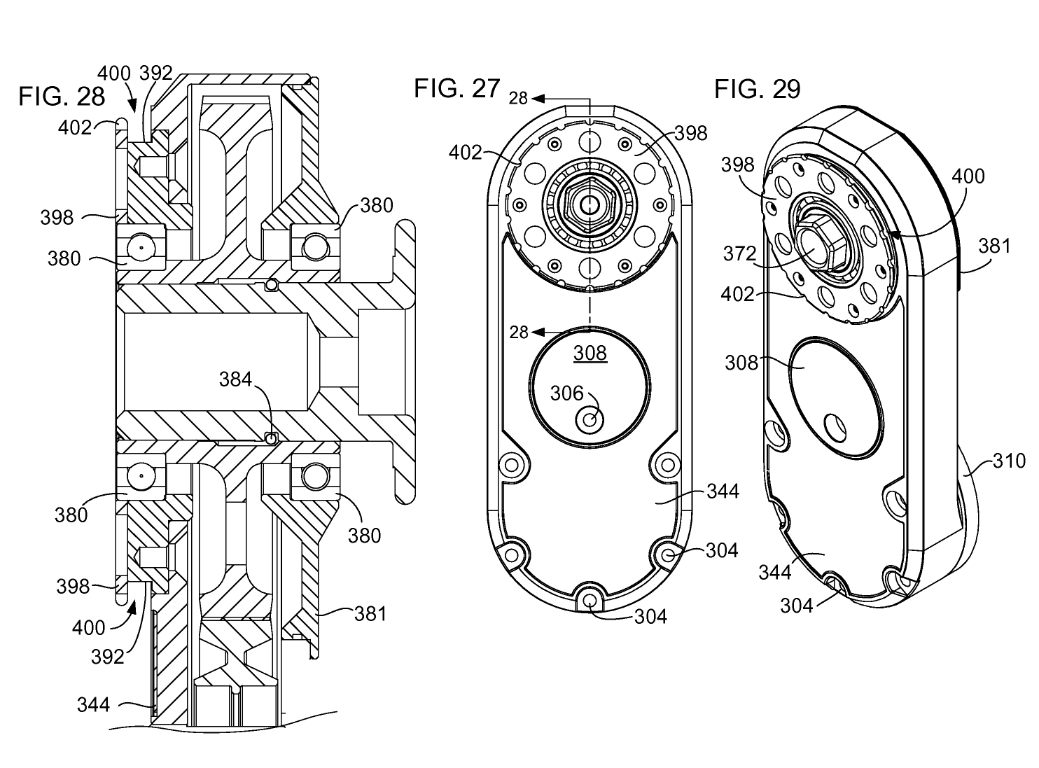

The gearbox 116 (FIGS. 21-29) is mounted to and supported by the housing of the drive assembly through six fasteners passing from the outside of the gearbox through the wall of the drive assembly housing and into the mounting ring 302 (FIG. 15). Respective bores 304 are formed in the perimeter wall of the gearbox every 60 degrees from a center axis defined by the central axis of the blade drive input shaft. A sixth bore 306 extends through a medial gear shaft 308, discussed more fully below. The fasteners apply sufficient pressure from a clutch plate 310 to the clutch 300 so that movement or rotation of the arm rotation gear 298 moves the gearbox 116 about the axis defined by the blade drive input gear shaft.

The gearbox 116 also includes the inner blade flange 118 mounted to a blade drive shaft for driving the blade 114 (FIG. 3). The inner blade flange includes a first plurality of threaded openings 312 oriented on a first circle for receiving fasteners for mounting a blade having mounting holes corresponding to a first mounting configuration, and a second plurality of threaded openings 314 oriented on a second circle for receiving fasteners for mounting the blade according to a second mounting configuration. The inner mounting flange also includes a plurality of channels 316 for guiding cooling fluid such as water from the flange along the outside of the blade. Additional channels 318 can be used to pass water to an outer blade flange 120 (FIG. 1) if an outer blade flange is used. A blade supporting boss 320 extends outward from the face 322 of the inner blade flange for supporting the blade and for engaging the outside of a complementary surface on the outer blade flange 120.

The body 324 of the gearbox is formed from hard aluminum with surfaces machine or formed so as to receive appropriate components for the gearbox. The outer side 326 and the inner side 328 of the gearbox body include recesses 320 and 322, respectively, machined, milled or otherwise formed in the outer and inner sides of the gearbox. The recesses produce a lighter-weight gearbox to the extent of the material removed. The recesses 320 are bordered on the outside by a perimeter ledge 324. The perimeter ledge 324 extends around the entire perimeter of the area within which the recesses 320 are found. The perimeter ledge 324 has a width extending inward from the rim 326 to the adjacent recess for receiving a layer of adhesive having approximately the same width. The body 324 of the gearbox also includes a perimeter ledge 328 extending outward approximately the same width from a circular rim 330 that receives the medial gear shaft 308 (FIG. 21). The perimeter ledge 328 also receives a layer of adhesive approximately the same width as the width of the adhesive layer on the perimeter ledge 324. The body 324 of the gearbox further includes supplemental bonding surfaces 332 also for receiving an adhesive layer. The dimensions of the supplemental bonding surfaces are selected so as to optimize as much as possible the strength of the gearbox while lowering the overall weight.

The recesses 322 on the inner side 328 of the gearbox body are also bordered on the outside by a perimeter ledge 334 extending around a significant portion of the perimeter of the area within which the recesses 322 are found. The perimeter ledge 334 has a width extending inward from the rim 336 for receiving a layer of adhesive having approximately the same width. The remainder of the perimeter around the recesses 322 is occupied by an enlarged bonding surface area 338 extending around a significant portion of a support arm 340 that supports the medial gear shaft and the fastener that extends through the medial gear shaft. Supplemental bonding surfaces 342 extend between the large bonding surface area and the perimeter ledge 334. The enlarged bonding surface area 338 and the supplemental bonding surfaces 342 receive a layer of adhesive having a width corresponding approximately to the surface area of those bonding surfaces.

The thickness of the adhesive layer on these surfaces is approximately 0.005 in. and has the characteristics the same as or similar to the adhesive layers discussed in International Application Number WO 2003/080304, incorporated herein by reference.

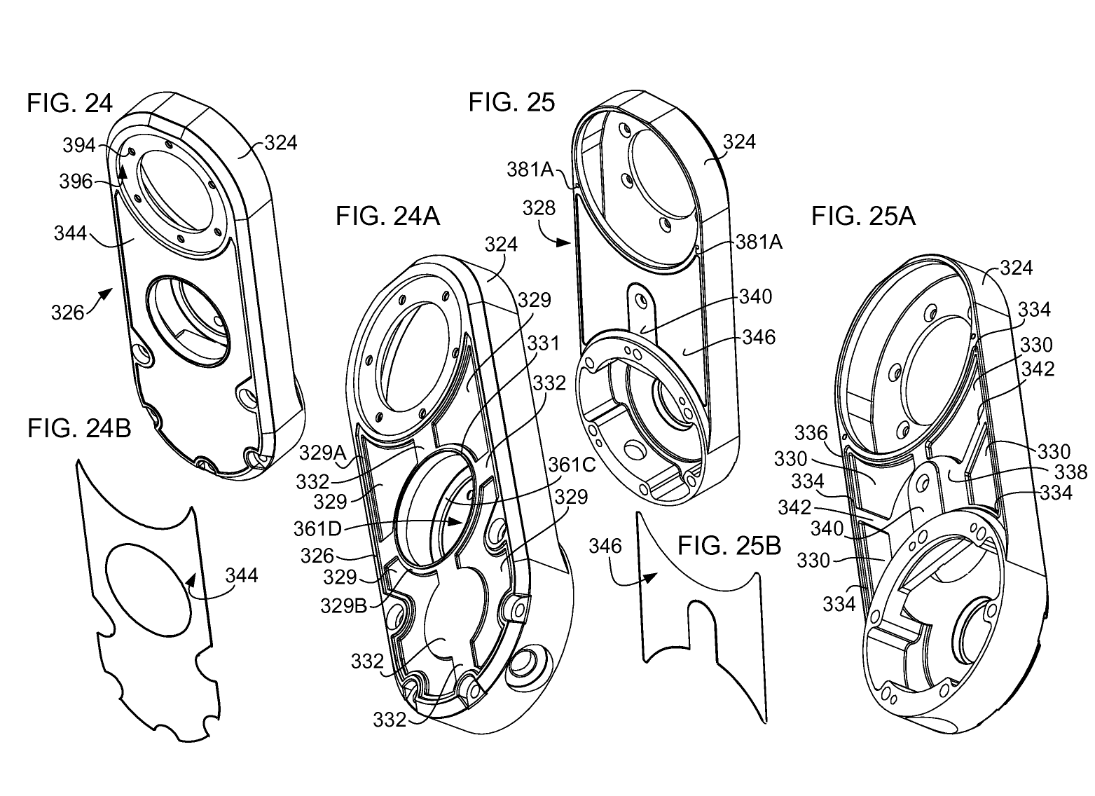

On the outer side 326, a layer of composite material 344 is adhered to the perimeter ledge 324, perimeter ledge 328 and the supplemental bonding surfaces 332 through the layer of adhesive. The composite material layer 344 has the outline shown in FIG. 24B. The composite material layer 344 is formed from any epoxy resin with carbon, glass or other fiber reinforcement embedded in the epoxy. The composite material layer is substantially flat and has a substantially uniform thickness. The composite material layer is configured in a manner similar to those discussed in International Application Number WO 2003/080304. The composite material layer is preferably an eight harness layup, wide weave, but may also be other configurations, including those discussed in International Application Number WO 2003/080304. However, the fibers are preferably oriented fiber reinforcement.

On the inner side 328, a layer of composite material 346 is adhered to the perimeter ledge 334 and to the enlarged bonding surface area 338 and the supplemental bonding surfaces 342 through the layer of adhesive. The composite material layer 346 has the outline shown in FIG. 25B and is formed to be substantially identical to the layer 344 except for the outline profile.

Each of the composite material layers forms a portion of the gearbox housing or body and provides tensile strength to the gearbox. The use of the composite material layers reduces the weight of the gearbox while maintaining or enhancing the strength of the gearbox body. They help to reduce bending or twisting of the gearbox under the loads experienced during operation of the saw.

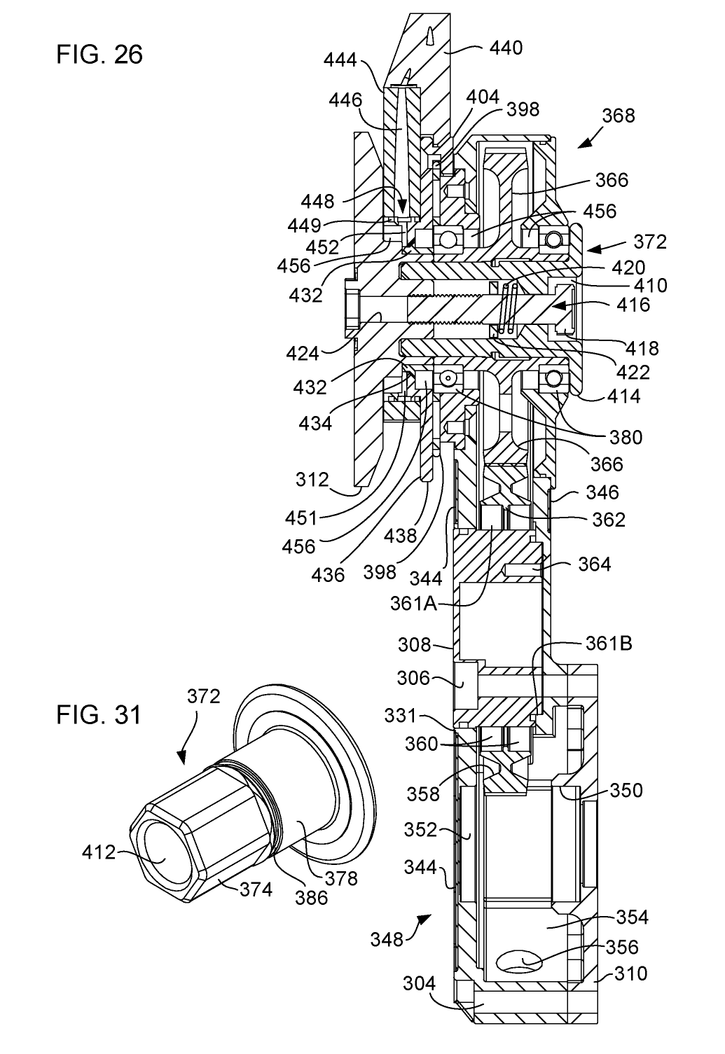

Considering the gearbox in more detail with respect to FIGS. 26-29 and 31, the input portion 348 includes the clutch plate 310, which is sandwiched between the body of the gearbox and the housing of the drive assembly. The clutch plate includes an opening for receiving the blade drive input shaft, which is supported by bearings (not shown) in counter bores 350 and 352. Lubricating fluid may be provided into an oil bath area 354 through an opening 356. The blade drive input shaft gear engages a medial gear 358, which is supported in the gearbox by the medial gear shaft 308 through a pair of radial bearings 360 positioned on opposite sides of a ring 362 on the interior surface of the gear. The radial bearings 360 are dimensioned so as to fit within the envelope defined by the width of the gear. The radial bearings 360 are spaced radially outward from the support shaft 308, and the gear 358 is spaced radially outward from the radial bearings 360. This packaging of the gear and the bearings allows a thinner gearbox relative to a gear supported on an axially longer shaft with bearings outboard of the gear envelope.

The medial gear shaft 308 is supported laterally (“laterally” here meaning of the gearbox rather than laterally relative to the direction of cutting) by the walls of the gearbox. In the example shown in FIG. 26, the medial gear shaft includes two differently sized cylindrical portions 361A and 361 B. The first and larger diameter cylindrical portion 361A is supported by the gearbox wall defined in part by the rim 330 in the outer side 326 of the gearbox (FIGS. 24A and 26). The second and smaller diameter cylindrical portion 361B is supported from the sides by the sidewall 361C for a circular recess 361D on the inside surface of the gearbox inner side 328 (FIG. 24A). These portions of the gearbox walls help to support the medial gear shaft in side loading that the gear shaft experiences.

The medial gear shaft 308 is also supported axially by being held in place by a fastener through the bore 306 and by a fastener in the bore 364. The first fastener in the bore 306 is shared with the five other fasteners mounting the gearbox on the drive assembly. The fastener through the bore 306 extends completely through the interior of the medial gear 358. The gear turns around the fastener in the bore 306. The medial gear shaft 308 is sealed in the gearbox housing through O-rings (not shown) in the O-ring grooves in the perimeter of the medial drive shaft 308.

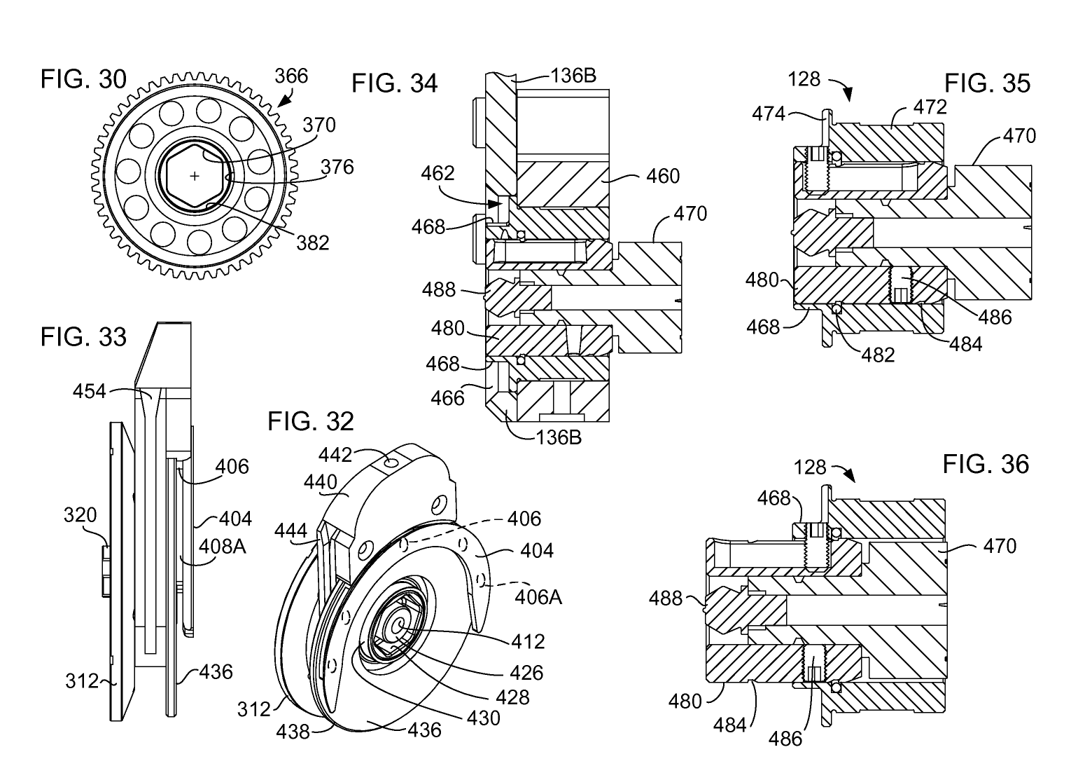

The medial gear drives a blade drive output gear 366 at an output portion 368 of the gearbox. The output gear 366 (FIG. 30) is a spur gear driven by the medial gear 358. The output gear includes a non-circular drive surface 370 for turning a blade output drive shaft 372 (FIGS. 26 and 31), and in the example shown in drawings, the drive surface 370 has a hexagonal configuration for receiving the hexagonal portion 374 on the blade drive shaft 372. The output gear also includes a substantially cylindrical support surface 376 for supporting the circular cylindrical portion 378 of the blade drive shaft. The output gear 366 is supported in the gearbox by radial bearings 380. The inner radial bearing is supported in the gearbox by a cover plate 381 mounted in the opening in the back side of the output portion 368 of the gearbox. The opening is sealed with an O-ring in an O-ring groove around the perimeter of the cover plate 381. The cover plate is held in place on the back of the gearbox housing through fasteners in the bores 381A (FIG. 25).

The output gear 366 also includes an annular groove 382 in the interior surface of the gear between the hexagonal portion 370 and the cylindrical portion 376 for receiving and capturing an O-ring 384 or other engagement element (FIG. 28) resting in an O-ring groove 386 in the blade output drive shaft 372. The O-ring helps to define a limited range of axial motion of the blade drive shaft 372 when the blade drive shaft is assembled in the blade output drive gear 376. With the O-ring in place and the drive shaft assembled with the gear, the drive shaft can travel axially between the position shown in the gearbox in FIG. 26 and the position shown in FIG. 28, where the position shown in FIG. 28 is a retracted position for the drive shaft. In the retracted position, the gearbox can more easily receive a blade flange assembly with a blade.

The opening in the front of the output portion of the gearbox housing is covered by a cover plate 392 secured in place by six fasteners through the openings 394 (FIG. 24). The cover plate is received in a recess 396 in the output portion of the gearbox. The cover plate supports the radial bearings 380, and an indexing ring 398 (FIGS. 26 and 27-29). Additionally, when the inner blade flange assembly is being mounted on the blade drive shaft, a portion of the cover plate supports a grooved element on the inner blade flange assembly in a circumferential groove or trough 400. The circumferential groove 400 is formed between a lip on the cover plate 392 and the gearbox housing on one side, and the indexing ring 398 on the other side. The groove 400 extends around the entire circumference of the cover plate 392. As a result, the groove 400 can receive the arcuate portion (collar segment) of the inside blade flange assembly when the gearbox is at any orientation relative to the drive assembly and track.

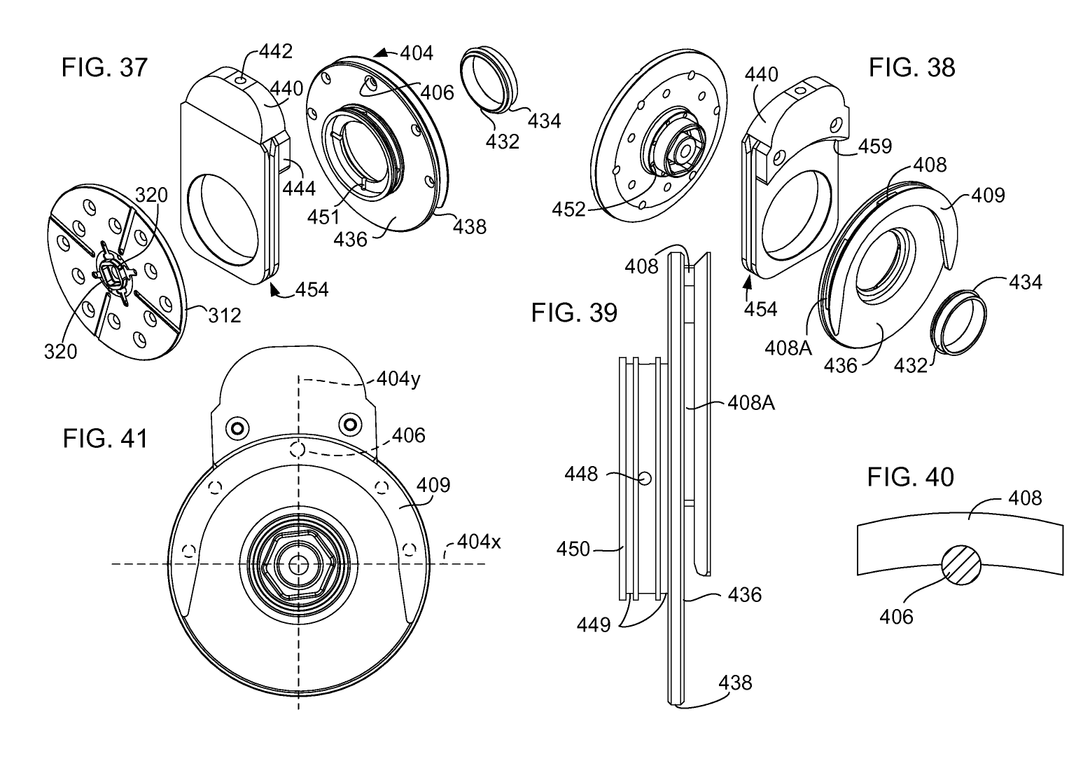

The indexing ring 398 includes outwardly extending grooves or notches 402 in the perimeter of the ring. The notches 402 are uniformly distributed about the circumference of the indexing ring 398, there being 18 notches around the circumference of the indexing ring 398 shown the drawings (the diameter of the indexing ring in the example wall saw is about 4.7 inches). Each notch is capable of receiving the side of a pin, rod, bar or other complementary structure in a grooved element or collar 402 on the inner blade flange assembly. In the example shown in the drawings, the grooved collar 404 includes a pin 406 (FIGS. 33, 37 and 40) for engaging any one of the notches 402. In the present example, the pin is a fastener that would extend into the front face of the collar shown in FIG. 37 (though the fastener is not shown in FIG. 37). The pin 406 also holds in place at the center of the collar 404 (the top of the collar on the Y-axis 404y in FIG. 41 when the collar is positioned as shown in FIGS. 3740) an arcuate-extending support spacer 408, having a radius of curvature substantially the same as the radius of curvature of the indexing ring 398. Two pairs of fasteners on each side of the pin 406 also fix in place respective arcuate-extending support spacers 408A. The support spacers 408A extend in opposite directions from the pin 406, and also have radii of curvature substantially the same as that for the indexing ring 398. The ends of the spacers 408A fall almost 90 degrees from the pin 406.

The spacers support a collar segment 409 (or they may be formed integral with the collar segment) that extends in an arc over more than 180 degrees of the collar 404. As can be seen in FIG. 41, the collar segment has a segment width that is substantially constant over 180 degrees, and thereafter decreases to a zero width at the ends of the collar segment. In the example shown in FIG. 41, the convergence of the outer and inner sides of each end of the collar segment occurs over a short distance because the inside surface of the collar segment end extends outwardly to the perimeter rather than straight down from the X-axis 404x. The width of the collar segment 409 is preferably greater than the depth of a notch 402, so that the collar segment extends over more than an insubstantial edge portion of the indexing ring 398. The width is preferably such as to reliably keep a blade and blade flange assembly on the indexing ring while the blade arm is stationary, allowing the operator to fix the blade flange on the blade shaft before running the blade. The overlap distance that the collar segment extends beyond the perimeter of the indexing ring may be as much as twice the depth of a notch 402, or more, but it could be less than twice. However, the exemplary collar segment extends over the indexing ring perimeter over more than 180 degrees of the ring.

When the inner blade flange assembly is placed on the blade arm, the pin contacts the circumferential surface of the indexing ring 398. At least one of the spacers 408 and 408A may also come to rest against the facing surface of the indexing ring 398. If the operator tries to shift the collar 404 of the blade flange assembly along the indexing ring, and the pin 406 is in a notch 402, then the spacers will also be resting on the adjacent circumferential edge surfaces of the indexing ring 398. If the blade flange assembly moves, it will move sufficiently so that the pin will then come to rest in a notch 402, and the blade flange assembly will then be supported on the indexing ring 398. The dimensions of the pin 406, the spacers 408 and 408A, and the size of the indexing ring 398 are such that the associated notch 402 and an arcuate portion of the circumference of the indexing ring 398 support the opposing surfaces of the grooved portion 404 which are contacting the indexing ring 398. Once supported, the inner blade flange assembly has little freedom of movement on the indexing ring 398 and the grooved portion 400. Additionally, that portion of the inner blade flange to mate with the hexagonal blade drive shaft is in alignment with the blade drive shaft, though the flats of the hexagonal shaft may not be completely aligned with the flats on the blade flange.

The blade drive shaft 372 includes a first bore 410 and a second bore 412 (FIGS. 26 and 31) in the center of the blade drive shaft. The first bore 410 opens out to the inside portion of the blade drive shaft where a flange 414 rests against the inner bearing assembly 380 when the blade drive shaft is in the position shown in FIG. 26. The blade drive shaft receives a blade flange mounting bolt 416 having a bolt head 418 received in the first bore 410. The threaded portion of the bolt extends through an opening between the first bore and the second bore and extends to the end of the blade drive shaft when the head 418 of the bolt rests against the bottom of the first bore 410. In FIG. 26, the bolt has not been fully threaded into the bore 424 of the inner blade flange, and the head 418 is not seated at the bottom of the first bore 410. The blade drive shaft also includes a compression spring 420 between the bottom of the second bore and a retaining ring 422 on the shaft of the bolt. The retaining ring is fixed on the bolt axially, and is dimensioned so as to substantially center the bolt in the second bore 412, so that the bolt is aligned with the threaded bore 424 in the inner blade flange 312. The bore 424 is threaded the entire length of the bore. The compression spring 420 biases the bolt outward of the second bore 412 and toward the inner blade flange 312. When the inner blade flange is properly aligned with and oriented with respect to the hexagonal surfaces on the blade drive shaft 372, turning the bolt 416 threads the bolt into the threaded bore 424, drawing the blade flange into engagement with the hex surfaces on the blade drive shaft, until the blade drive shaft and the inner blade flange are fully engaged, as shown in FIG. 26, though the bolt will be threaded further into the bore 424.

Considering the inner blade flange assembly in more detail, the blade flange 312 includes a circular boss 426 with the threaded bore 412 extending through the center of the circular boss. Spaced sideways from the outer wall of the circular boss are non-circular wall portions, in the present example a hexagonal wall 428 surrounding the boss 426. The boss 426 extends into the second bore 412 of the blade drive shaft and the threaded bore 412 receives the bolt 416. The inside surfaces of the hexagonal wall 428 slide over the hexagonal portion 374 of the blade drive shaft 372, so that the blade drive shaft can turn the inner blade flange 312. The hexagonal wall 428 includes a circular outer wall 430 for receiving a press fit metal sealing ring 432 (FIG. 26) extending from the back side of the inner blade flange the entire axial length of the circular wall 430. When the blade flange assembly is securely mounted on the gearbox, the sealing ring 432 bears against the outer radial bearing assembly 380 and rotates with the inner blade flange 312. The sealing ring 432 includes a slanted surface 434 for sealing against a complementary corresponding surface on a stationary face plate or collar 436 (FIGS. 26 and 32-33) that contacts the outer surface of the indexing ring 398, as shown in FIG. 26. The outer circumferential wall 438 of the collar 436 extends beyond the outer circumference of the indexing ring 398.

The collar 436 supports a water inlet manifold 440 (FIGS. 26 and 32-33) having a water inlet 442 for feeding blade cooling water to a water manifold 444. The water manifold includes at least one channel 446 feeding water to one or more collar outlets 448 between two O-ring seal areas 449 on a water inlet ring 450 on the collar 436. The water inlet ring fits inside the complementary opening in the water manifold 444, against which the O-rings seal. The collar outlets 448 feed the water to grooves 451 in the water inlet ring 450 and then to blade flange inlet openings 452 (FIG. 38).

The water manifold 444 and the inlet 440 remain stationary (along with the blade guard engaging the water manifold) relative to the cutting surface, so that the water inlet manifold 440 orientation remains substantially the same with rotation of the gearbox relative to the drive assembly. The water inlet manifold 440 and the water manifold 444 can rotate about the O-ring seals 449 during rotation of the blade arm/gearbox. The outside of the water manifold 444 includes grooves 454 for receiving complementary structures associated with a blade guard, which also help to maintain the orientation of the water manifold and blade guard even while the blade arm/gearbox rotates relative to the cutting surface. Lip seals 456 are included in the output portion of the gearbox and the inner blade flange assembly for sealing the adjacent structures.

When the drive assembly and associated gearbox are properly mounted on the track, a blade and blade flange assembly can be mounted on the blade arm/gearbox. A blade is first mounted on the blade flange assembly. In the case of a flush cut operation, the blade is fastened to the inner blade flange through appropriate fasteners into the face of the inner blade flange. In other cutting operations, the blade 114 is mounted between the inner and outer blade flanges, using a bolt threaded into the outer end of the threaded bore 424 in the inner blade flange. The inside of the surface 320 on the inner blade flange engages the outside of a complementary surface on the inside of the outer blade flange to reduce the tendency of blade rotation to un-thread the blade mounting bolt from the threaded bore 424.

The blade drive shaft 372 is then pressed flush with the outer portion of the gearbox, either manually or by pressing the blade and blade flange assembly against the drive shaft, so that the drive shaft is positioned as shown in FIG. 28. The blade and blade flange assembly is then moved sideways into engagement with the indexing ring 398 so that the pin 406 engages a notch 402, either directly or after shifting the collar and blade flange assembly in one direction or the other until the pin 406 engages a notch. In one configuration, the pin 406 is placed in the vertically upper-most notch 402 or either of its two adjacent notches for the given blade arm/gearbox orientation. The blade and blade flange assembly can be moved into engagement with the indexing ring 398 for any angular position that the blade arm/gearbox is found in. With 18 notches in the circumference of the indexing ring, the pin 406 can easily be positioned in an upper-most notch. If the pin happens to rest outside of a notch, the blade can be moved several degrees in one direction or the other until the pin comes to rest in a notch.

Because of the angular distribution of the notches 402, the hex surfaces of the drive shaft 372 may align with the hex surfaces 428 on the blade flange assembly. Proper alignment can be checked by pressing on the flange 414 of the blade drive shaft 372. If the hex surfaces are aligned, the blade shaft will engage the blade flange assembly and advance a small amount, and the blade shaft flange will turn in the operator's hand with the blade. The bolt 416 is then threaded into the bore 424. If the hex surfaces are not aligned, the operator can grasp the blade and rotate it a few degrees until the blade shaft can be pressed into engagement with the blade flange assembly, after which the blade shaft flange will turn with the blade. The bolt 416 is then threaded into the bore 424. In one configuration, the bolt length is such that it will not thread into the bore 424 until the hex surfaces on the drive shaft extend partly along the hex wall 428 in the blade flange assembly. In another configuration, the bolt end is such that it can begin threading without advancing the blade shaft. In a further configuration, the bolt can begin threading before the drive shaft and flange are completely engaging. In the present example shown in the drawings, the bolt is configured to have its threaded end flush with the drive shaft end before the blade flange is placed on the blade arm. The spring 420 helps to bias the bolt 416 into engagement with the threads in the bore 424 of the blade flange assembly, so when the hex surfaces are aligned, the bolt can be threaded into the blade flange. While the operator is engaging the blade drive shaft with the flange assembly, the indexing ring 398 and the groove 400 support the blade and blade flange assembly. Therefore, the operator's hands are free to securely mount the blade and blade flange assembly on the saw.

In some cutting situations, the saw may be arranged so that the arm is below the saw, and it is difficult to place the blade flange assembly on the upper-most surface of the indexing ring. For example, the wall saw may be mounted close to a ceiling that precludes raising the blade and blade flange assembly high enough to place the collar on an upper portion of the indexing ring. The operator may then orient the blade flange assembly so that the open end of the collar segment is directed upward. The assembly including the collar is then moved against a lower portion of the indexing ring until the pin 406 engages a notch. The water manifold 444 (and the water inlet manifold 440) is then pivoted until the water inlet manifold is substantially diametrically opposite the pin 406. In that orientation, the arcuate rim 459 on the water inlet manifold faces the collar segment, and between them substantially surround the indexing ring. The blade and blade flange assembly is then substantially prevented from coming off the indexing ring as long as the diametrical spacing between the inner edge of the collar segment and the inner edge of the arcuate rim 459 is less than the diameter of the indexing ring. While gravity will pull the collar plate away from the indexing ring 398, the arcuate rim 459 stops the collar from falling free of the indexing ring, and specifically, the ends of the collar segment will still help to hold the blade flange assembly in place.

When cutting is complete, or to change blades, the saw is turned off and the blade allowed to stop. The bolt 416 is backed out and the blade shaft removed from the hex wall 428. When the blade shaft is free of the blade flange, the blade and blade flange assembly can be removed by lifting the assembly from the indexing ring and the groove 400.

In the carriage 110 (FIGS. 1 and 2), the lower roller assemblies 128 when extended inside the carriage have outer portions that are flush with or recessed below the outer side surfaces of the corresponding side legs 130. Having the roller assemblies 128 flush or recessed when in the operating configurations provides for a narrower overall carriage width during operation. Each of the roller assemblies 128 is positioned in a bore through an inside leg portion 460 of the carriage body 111 (FIG. 34) and is set within a counter bore 462 through the side plate 136B mounted on the outside surface of the leg portion 460. The counter bore 462 includes a bevel surface 466 to help in providing access to the counter bore and to the hex surface 468 on the roller assembly 128. The hex flat surfaces on each roller assembly are used to adjust the vertical positions of the cam follower rollers 470 on the assemblies (FIGS. 34-36). Each assembly includes an outer bushing 472 having a flange 474, where the bushing engages the bore in the leg portion 460 and the flange rests against the outer surface of the leg portion 460, within the counter bore 462. A slider sleeve 480 slides within the outer bushing, and rotation of the hex surfaces rotates the slider relative to the outer bushing. A lock ring 482 engages detents 484 in the outer surface of the slider sleeve 480 and provides an indication of the length of travel of the slider sleeve and therefore the roller 470. The roller is fixed in the slider sleeve by set screw 486. A lubricating fitting 488 allows lubrication of the roller.

The dimensions of the roller assembly, including the flange 474 and the hex surfaces 468 are such that the roller assembly has a low-profile relative to the respective leg 130. When the roller is in place for operation, the profile of the roller assembly is preferably below or inward of the outer-most surface of the surrounding portion of the carriage. The hex surfaces 468 and the counter bore 462 are preferably dimensioned so as to provide adequate access to the hex surfaces for adjusting the rollers.

The carriage also has a reduced overall width in part due to the handle zircs being recessed, as discussed previously relative to the bushing 200 and FIGS. 7 and 7A. Reducing the overall width of the carriage allows the saw blade to cut in a plane closer to the plane occupied by the rack and by the track overall. Moreover, having the cutting plane as close as possible to the track reduces the loading on the track and various moment forces experienced in the equipment that must be accounted for in the strength and expected life of the various parts. There are also additional ways to reduce loading on parts. In one example, as shown in FIG. 3, one or more portions of the gearbox/blade arm can be positioned inboard over a part of the carriage. In the example shown in FIG. 3, part of the flange 414 on the blade drive shaft 372 (FIGS. 26 and 31) extends over a part of the carriage. The flange is partly inboard of one or more of the fasteners 492 on the carriage. Placing part or all of one or more components closer to the track reduces the side loading or moment forces experienced by the saw, the track and related components, thereby permitting design improvements such as lighter components and the like. Additionally, to the extent that the gearbox/blade arm can be positioned and operated closer to the carriage, and to the track, the components and operation of the saw can be improved. In the present example, the gearbox/blade arm under the blade drive shaft flange 414 passes within less than 0.2 inches of the carriage, representing a significant reduction in the spacing of the gearbox/blade arm relative to the carriage. Likewise, to give added clearance to the blade arm/gearbox passing the carriage, the outer lower end surfaces 494 of the legs 130 are radiused or beveled as shown in the drawings.

Having thus described several exemplary implementations, it will be apparent that various alterations and modifications can be made without departing from the concepts discussed herein. Such alterations and modifications, though not expressly described above, are nonetheless intended and implied to be within the spirit and scope of the inventions. Accordingly, the foregoing description is intended to be illustrative only.

1. A movable machine comprising:
a carriage for moving along a surface;
a movement element supported by the carriage for moving the carriage along the surface;
a drive element removably supported by the carriage at a first position on the carriage with the drive element having an engagement surface adapted to engage a first complementary element on the carriage and wherein the drive element is movable to a second position on the carriage at which the engagement surface on the drive element engages a second surface element on the carriage and wherein the drive element includes at least one surface for supporting a machine tool.

2. The machine of claim 1 wherein the machine tool is a saw and the drive element is a saw motor element removably supported on the carriage.

3. The machine of claim 1 wherein the movement element is a rack drive element for moving the carriage along the track.

4. The machine of claim 3 wherein the rack drive element is a gear in the carriage for engaging the rack for moving the carriage along the rack.

5. The machine of claim 4 wherein the carriage includes a wall defining an opening and the gear is substantially accessible from two sides of the gear.

6. The machine of claim 5 wherein the carriage includes a wall defining in opening and the gear is substantially centered in the opening.

7. The machine of claim 4 wherein the carriage includes a drive device for engaging the gear and driving the gear.

8. The machine of claim 7 wherein the carriage moves along a line and the drive devices a first drive device oriented at an angle relative to the line.

9. The machine of claim 8 wherein the carriage includes a second drive device oriented in the carriage at a second angle relative to the line different from the angle of the first drive device.

10. The machine of claim 1 wherein the drive element is supported on the carriage so that the drive element includes a first portion extending in a first direction and wherein the engagement surface is oriented at a first angle relative to the first direction.

11. The machine of claim 10 wherein the drive element includes a second portion substantially a mirror image of the first portion.

12. The machine of claim 11 wherein the second portion is positioned on a portion of the drive element substantially opposite the first portion.

13. The machine of claim 12 wherein the first and second portions include surfaces slanting in substantially opposite directions.

14. The machine of claim 1 further including a drive portion for engaging the movement element and wherein the engagement surface is a first engagement surface and the carriage further includes a second engagement surface wherein the drive portion is positioned between the first and second engagement surfaces.

15. The machine of claim 14 wherein the drive portion is substantially centered between the first and second engagement surfaces.

16. The machine of claim 14 wherein the drive portion is reversible relative to the carriage.

17. A movable machine comprising:
a moving assembly for moving the movable machine in a first direction;
a drive assembly for driving the moving assembly in the first direction, wherein the drive assembly is removably supported by the moving assembly and wherein the moving assembly and the drive assembly include respective engagement elements for releasably securing the moving and the drive assemblies together; and
a manual engagement release configured for manual actuation for releasing one engagement element from the other.

18. The machine of claim 17 wherein the moving assembly is a carriage having a driven element and wherein the drive assembly includes a motor for driving the driven element and wherein the machine further includes a handle and wherein the handle includes a release element for actuating the manual engagement release.

19. The machine of claim 18 wherein the release element on the handle is biased.

20. The machine of claim 17 wherein the manual engagement release has a lock configuration and an unlocked configuration where the drive assembly can be released from the moving assembly with the manual engagement release is changed from the locked configuration to the unlocked configuration.

21. The machine of claim 20 wherein the manual engagement release has an intermediate configuration wherein the drive assembly is supported by the moving assembly in the intermediate configuration.

22. The machine of claim 21 wherein the drive assembly and the moving assembly are configured such that the drive assembly can not be removed from the moving assembly when the manual engagement release is in the intermediate configuration.

23. The machine of claim 22 wherein the Mandel engagement release includes a handle and the handle includes a spring biased latch release.

24. A saw comprising:
a carriage for moving along a surface;
a cutting head removably mounted to the carriage, wherein the cutting head includes a support for a saw blade and further includes a first surface; and
a movable element supported by the carriage and having a second surface at least partly complementary to the first surface and wherein the second surface engages the first surface with movement of the movable element and wherein the movable element is configured to move the movable element into engagement with the first surface without the use of threads.

25. The saw of claim 24 wherein the movable element includes a handle.

26. The saw of claim 25 wherein the second surface on the movable element has a curved surface for contacting the first surface.

27. The saw of claim 25 wherein the movable element further includes a spring-biased latch element.

28. A concrete saw comprising:
a drive assembly that can be moved in a cutting direction, the drive assembly including a support for a cutting blade;
a blade drive element for driving a cutting blade, the blade drive element including a drive shaft supported by the drive assembly and having a first axis; and
a travel element supported by the drive assembly for moving the saw along a surface and wherein the travel element is parallel with the first axis.

29. The saw of claim 28 wherein the blade drive element includes a blade input shaft and wherein the travel element includes a travel gear coaxial with the blade input shaft.

30. The saw of claim 28 wherein the blade drive element and the travel element have rotating portions that are concentric with each other.

31. The saw of claim 28 further including a carriage supporting the drive assembly and wherein the carriage includes a gear substantially centered widthwise of the carriage and engaging a driving gear in the drive assembly for moving the carriage.

32. A concrete saw comprising a carriage for moving the saw along a surface, a single off-center gear for engaging a rack on a track, wherein the single gear extends from an underside of the carriage.

33-36. (canceled)

37. A saw having a gearbox including an input to the gearbox and an output from the gearbox, wherein the output includes a drive shaft for cutting blade, and the gearbox includes at least one gear within the gearbox turning on an axis and having a gear width in an axial direction, and at least one bearing supporting the gear within the width of the gear and wherein the bearing has a bearing width in the axial direction less than the gear width.

38. The saw of claim 37 wherein the gear includes two bearing assemblies supporting the gear having a combined bearing assembly width in the axial direction no greater than the gear width.

39. A wall saw comprising:
a saw motor and a saw arm wherein the saw motor can be used to drive a saw blade and the saw arm is configured to support a saw blade;
an engagement assembly for receiving a blade flange assembly, the engagement assembly including a plurality of alignment elements for aligning with at least one alignment element on a blade flange assembly, wherein the plurality of alignment elements are spaced apart from each other.

40. The saw of claim 39 wherein the engagement assembly includes a substantially circular plate having notches substantially uniformly distributed about a circumference of the plate.

41. The saw of claim 39 wherein the engagement assembly includes a blade drive shaft having a non-circular surface for engaging the complementary alignment elements on the blade flange assembly.

42. The saw of claim 41 wherein the blade drive shaft includes a hexagonal surface.

43. The saw of claim 42 wherein the blade flange assembly includes a hexagonal surface.

44. A wall saw comprising:
a carriage for moving along a track;
a blade drive motor;
a blade drive shaft for accepting and supporting a saw blade flange wherein the blade drive shaft has a non-circular portion for receiving a blade flange.

45. The wall saw of claim 44 wherein the blade drive shaft non-circular portion is hexagonal.

46. The wall saw of claim 45 further including a drive gear for the blade drive shaft wherein the drive gear includes a hexagonal portion.

47. A wall saw having a carriage for moving along a track wherein the carriage includes a lateral adjustment assembly and wherein the lateral adjustment assembly includes an eccentric shaft.

48. The wall saw of claim 47 wherein the lateral adjustment assembly includes a roller symmetric about a central axis.

49. A wall saw comprising:
a carriage for moving along a track;
a blade drive motor;
a gear for driving a blade drive shaft wherein the gear has a non-circular portion for driving the blade drive shaft.

50. The wall saw of claim 49 further including a blade drive shaft and wherein the gear includes a hexagonal surface engaging a hexagonal surface on blade drive shaft.
